(19) United States
(12) Patent Application Publication
(10) Pub. No.: US 2026/0094616 A1
(43) Pub. Date: Apr. 2, 2026

(54) MAGNETIC TAPE, MAGNETIC TAPE CARTRIDGE, AND MAGNETIC TAPE APPARATUS

(71) Applicant: FUJIFILM Corporation, Tokyo (JP)

(72) Inventors: Takuto KUROKAWA, Minamiashigara-shi (JP); Akinori HIRATA, Minamiashigara-shi (JP)

(73) Assignee: FUJIFILM Corporation, Tokyo (JP)

(21) Appl. No.: 19/316,201

(22) Filed: Sep. 2, 2025

(30) Foreign Application Priority Data
Sep. 27, 2024 (JP) 2024-169103

(51) Int. Cl. G11B 5/78; G11B 5/008

(52) U.S. Cl. CPC G11B 5/78; G11B 5/00813

(57) ABSTRACT

The magnetic tape includes a non-magnetic support, and a magnetic layer containing a ferromagnetic powder. Both an average valley depth Rvm measured at one edge portion of a surface of the magnetic layer and an average valley depth Rvm measured at the other edge portion are −0.55 μm or more and −0.20 μm or less. The edge portion is a portion of 0 μm to 1 μm in a tape width direction in a case where a position of an edge is 0 μm.

### CROSS-REFERENCE TO RELATED APPLICATIONS

This application claims priority under 35 U.S.C 119 to Japanese Patent Application No. 2024-169103 filed on Sep. 27, 2024. The above application is hereby expressly incorporated by reference, in its entirety, into the present application.

### BACKGROUND OF THE INVENTION

### 1. Field of the Invention

The present invention relates to a magnetic tape, a magnetic tape cartridge, and a magnetic tape apparatus.

### 2. Description of the Related Art

There are two types of magnetic recording media: a tape shape and a disk shape, and a tape-shaped magnetic recording medium, that is, a magnetic tape is mainly used for data storage applications such as data backup and archiving (for example, see JP2016-524774A, US2019/0164573A1, JP6590102B, and JP1996-279148A (JP-H08-279148A)).

### SUMMARY OF THE INVENTION

Recording of data on a magnetic tape is usually performed by running the magnetic tape in a magnetic tape apparatus and recording the data on a data band by making a magnetic head (also simply referred to as a “head”) follow the data band of the magnetic tape. Thereby, a data track is formed in the data band. In addition, in a case where the recorded data is reproduced, the data recorded on the data band is read by running the magnetic tape in the magnetic tape apparatus and by making the magnetic head follow the data band of the magnetic tape.

In order to increase an accuracy of the magnetic head following the data band of the magnetic tape in recording and/or reproduction as described above, a system for performing head tracking using a servo signal (hereinafter, it is described as a “servo system”) has been put into practical use.

Further, it has been proposed to acquire information on dimensions (contraction, extension, or the like) in a width direction of the magnetic tape during running by using a servo signal and to change an angle (hereinafter, also referred to as a “head tilt angle”) at which an axial direction of a module of a magnetic head is tilted against the width direction of the magnetic tape according to the acquired dimension information (see JP2016-524774A and US2019/0164573A1, for example, paragraphs 0059 to 0067 and 0084 of JP2016-524774A). During recording or reproduction, in a case where the magnetic head for recording or reproducing data records or reproduces data while being deviated from a target track position due to the width deformation of the magnetic tape, a phenomenon such as overwriting of recorded data or reproduction failure may occur. The present inventor considers that changing the head tilt angle as described above is one of means for suppressing the occurrence of such a phenomenon.

For example, assuming that the head tilt angle is changed as described above, it is desirable that running stability of the magnetic tape is high, in a case of recording and/or reproducing data by tilting an axial direction of a module of a magnetic head against the width direction of the magnetic tape (that is, tilting the head). This is because it is considered that the high running stability of the magnetic tape can lead to, for example, further suppressing the occurrence of the above phenomenon.

By the way, in recent years, the magnetic tape has been used in a data center where a temperature and a humidity are controlled.

On the other hand, the data center is required to save power in order to reduce costs. In order to save power, it is desirable that control conditions of the use environment of the magnetic tape in the data center can be more relaxed than a current level or the controlling can be made unnecessary.

However, in a case where the control conditions of the use environment are relaxed or the controlling is not performed, it is assumed that the magnetic tape may be used, for example, in a high temperature and low humidity environment. Therefore, a magnetic tape having excellent running stability in a case of recording and/or reproducing data by tilting the head in a high temperature and low humidity environment is desirable.

An object of one aspect of the present invention is to provide a magnetic tape having excellent running stability in a case of recording and/or reproduction by tilting a head in a high temperature and low humidity environment.

One aspect of the present invention is as follows.

[1] A magnetic tape comprising: a non-magnetic support; and a magnetic layer containing a ferromagnetic powder, in which both an average valley depth Rvm measured at one edge portion of a surface of the magnetic layer and an average valley depth Rvm measured at the other edge portion are −0.55 μm or more and −0.20 μm or less, and the edge portion is a portion of 0 μm to 1 μm in a tape width direction in a case where a position of an edge is 0 μm.

[2] The magnetic tape according to [1], in which a tape thickness of the magnetic tape is 5.0 μm or less.

[3] The magnetic tape according to [1] or [2], in which a vertical squareness ratio of the magnetic tape is 0.65 or more.

[4] The magnetic tape according to any one of [1] to [3], in which the non-magnetic support is an aromatic polyester support.

[5] The magnetic tape according to any one of [1] to [3], in which the non-magnetic support is an aromatic polyamide support.

[6] The magnetic tape according to any one of [1] to [5], further comprising: a non-magnetic layer containing a non-magnetic powder between the non-magnetic support and the magnetic layer.

[7] The magnetic tape according to any one of [1] to [6], further comprising: a back coating layer containing a non-magnetic powder on a surface side of the non-magnetic support opposite to a surface side having the magnetic layer.

[8] The magnetic tape according to any one of [1] to [7], in which a tape thickness of the magnetic tape is 5.0 μm or less, a vertical squareness ratio of the magnetic tape is 0.65 or more, the non-magnetic support is an aromatic polyester support or an aromatic polyamide support, the magnetic tape further includes a non-magnetic layer containing a non-magnetic powder between the non-magnetic support and the magnetic layer, and the magnetic tape further includes a back coating layer containing a non-magnetic powder on a surface side of the non-magnetic support opposite to a surface side having the magnetic layer.

[9] A magnetic tape cartridge comprising: the magnetic tape according to any one of [1] to [8].

A magnetic tape apparatus comprising: the magnetic tape according to any one of [1] to [8].

The magnetic tape apparatus according to [10], further comprising: a magnetic head, in which the magnetic head has a module including an element array with a plurality of magnetic head elements between a pair of servo signal reading elements, and the magnetic tape apparatus changes an angle θ formed by an axis of the element array with respect to a width direction of the magnetic tape during running of the magnetic tape in the magnetic tape apparatus.

According to one aspect of the present invention, it is possible to provide a magnetic tape having excellent running stability in a case of recording and/or reproduction by tilting a head in a high temperature and low humidity environment. In addition, according to one aspect of the present invention, it is possible to provide a magnetic tape cartridge and a magnetic tape apparatus which include the magnetic tape.

### BRIEF DESCRIPTION OF THE DRAWINGS

FIG. 1 is a schematic view showing an example of a module of a magnetic head.

FIG. 2 is an explanatory diagram of a relative positional relationship between a module and a magnetic tape during magnetic tape running in a magnetic tape apparatus.

FIG. 3 is an explanatory diagram relating to a change in an angle θ during magnetic tape running.

FIG. 4 shows an arrangement example of data bands and servo bands.

FIG. 5 shows an arrangement example of a servo pattern of a linear tape-open (LTO) Ultrium format tape.

FIG. 6 is an explanatory diagram of a measuring method of an angle θ during magnetic tape running.

FIG. 7 is a schematic view showing an example of the magnetic tape apparatus.

### DESCRIPTION OF THE PREFERRED EMBODIMENTS

### Magnetic Tape

One aspect of the present invention relates to a magnetic tape including a non-magnetic support and a magnetic layer containing a ferromagnetic powder. Both an average valley depth Rvm measured at one edge portion of the surface of the magnetic layer and an average valley depth Rvm measured at the other edge portion are −0.55 μm or more and −0.20 μm or less. The edge portion is a portion of 0 μm to 1 μm in the tape width direction in a case where a position of the edge is 0 μm. Hereinafter, both an average valley depth Rvm measured at one edge portion of the surface of the magnetic layer and an average valley depth Rvm measured at the other edge portion are collectively referred to as “edge portion Rvm”.

### Head Tilt Angle

The magnetic head may have one or more modules including an element array with a plurality of magnetic head elements between a pair of servo signal reading elements, and may have two or more or three or more modules. The total number of such modules may be, for example, 5 or less, 4 or less, or 3 or less, and the modules as many as the number exceeding the total number illustrated here may be included in the magnetic head. Arrangement examples of a plurality of modules include “recording module-reproducing module” (total number of modules: 2), and “recording module-reproducing module-recording module” (total number of modules: 3). Note that the present invention is not limited to the examples shown here.

Each module can include an element array with a plurality of magnetic head elements between a pair of servo signal reading elements, that is, an arrangement of the elements. A module having a recording element as the magnetic head element is a recording module for recording data on the magnetic tape. A module having a reproducing element as the magnetic head element is a reproducing module for reproducing data recorded on the magnetic tape. In the magnetic head, a plurality of modules are arranged, for example, in a recording and reproducing head unit such that axes of the element arrays of the respective modules are oriented in parallel. Such a term “parallel” does not necessarily mean only parallel in a strict sense, but includes a range of errors normally allowed in the technical field to which the present invention belongs. The range of errors can mean, for example, a range less than strictly parallel±10°.

In each element array, the pair of servo signal reading elements and the plurality of magnetic head elements (that is, the recording element or the reproducing element) are usually arranged linearly to be spaced from each other. Here, the term “arranged linearly” means that each magnetic head element is arranged on a straight line connecting a central portion of one servo signal reading element and a central portion of the other servo signal reading element. The term “axis of the element array” in the present invention and the present specification means a straight line connecting a central portion of one servo signal reading element and a central portion of the other servo signal reading element.

Next, a configuration of a module and the like will be further described with reference to the drawings. Note that the form shown in the drawings is an example and does not limit the present invention.

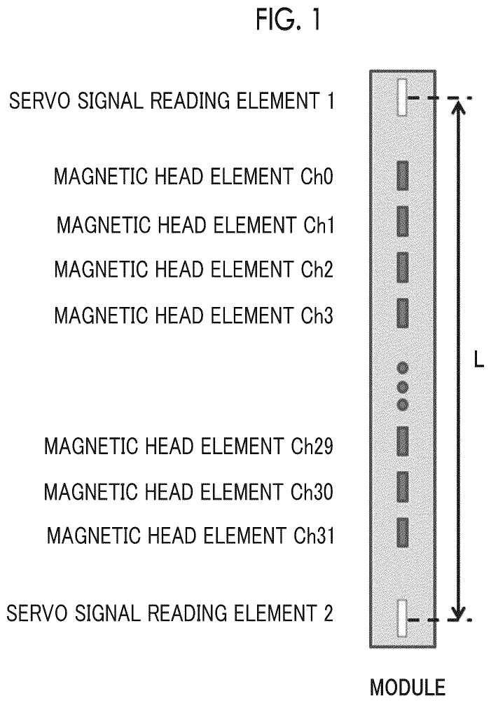

FIG. 1 is a schematic view showing an example of the module of the magnetic head. The module shown in FIG. 1 has a plurality of magnetic head elements between a pair of servo signal reading elements (servo signal reading elements 1 and 2). The magnetic head element is also referred to as a “channel”. “Ch” in the figure is an abbreviation for channel. The module shown in FIG. 1 has a total of 32 magnetic head elements from Ch0 to Ch31.

In FIG. 1, “L” represents a distance between a pair of servo signal reading elements, that is, a distance between one servo signal reading element and the other servo signal reading element. In the module shown in FIG. 1, “L” represents a distance between the servo signal reading element 1 and the servo signal reading element 2. Specifically, it is a distance between a central portion of the servo signal reading element 1 and a central portion of the servo signal reading element 2. Such a distance can be measured, for example, by an optical microscope or the like.

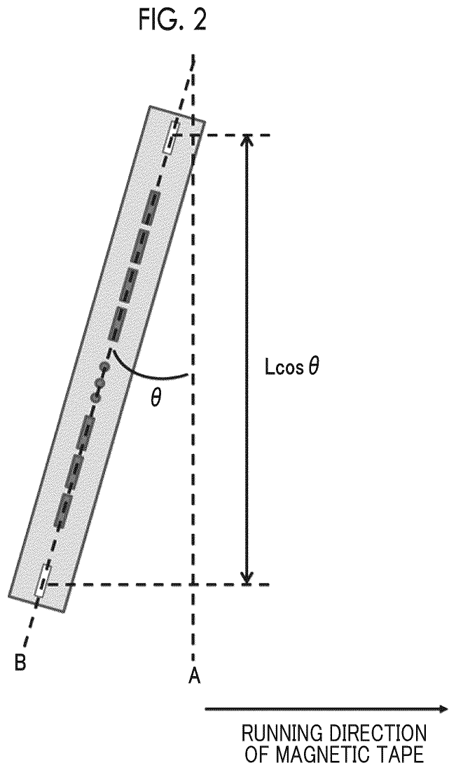

FIG. 2 is an explanatory diagram of a relative positional relationship between the module and the magnetic tape during running of the magnetic tape in the magnetic tape apparatus. In FIG. 2, the dotted line A indicates the width direction of the magnetic tape. The dotted line B indicates the axis of the element array. The angle θ can be said to be a head tilt angle during running of the magnetic tape, and is an angle formed by the dotted line A and the dotted line B. In a case where the angle θ is 0° during running of the magnetic tape, a distance in the magnetic tape width direction between one servo signal reading element and the other servo signal reading element in the element array (hereinafter, also referred to as “effective distance between servo signal reading elements”) is “L”. On the other hand, in a case where the angle θ exceeds 0°, the effective distance between the servo signal reading elements is “Lcosθ”, where Lcosθ is smaller than L. That is, “Lcosθ<L”.

As described above, during recording or reproduction, in a case where the magnetic head for recording or reproducing data records or reproduces data while being deviated from a target track position due to the width deformation of the magnetic tape, a phenomenon such as overwriting of recorded data or reproduction failure may occur. For example, in a case where the width of the magnetic tape contracts or expands, a phenomenon may occur in which the magnetic head element, which should perform recording or reproduction at a target track position, performs recording or reproduction at a different track position. In addition, in a case where the width of the magnetic tape expands, a phenomenon may occur in which the effective distance between the servo signal reading elements becomes shorter than an interval between two servo bands adjacent to each other with the data band interposed therebetween (also referred to as “servo band interval” or “interval between servo bands”, specifically, a distance between the two servo bands in the width direction of the magnetic tape), and data is not recorded or reproduced in a portion near an edge of the magnetic tape.

On the other hand, in a case where the element array is tilted at an angle θ exceeding 0°, the effective distance between the servo signal reading elements becomes “Lcosθ” as described above. The larger the value of 0, the smaller the value of Lcosθ, and the smaller the value of 0, the larger the value of Lcosθ. Therefore, by changing the value of 0 according to a degree of the dimension change (that is, contraction or extension) in the width direction of the magnetic tape, it is possible to make the effective distance between the servo signal reading elements approximate to or match with the interval between the servo bands. As a result, it is possible to prevent a phenomenon such as overwriting of recorded data or reproduction failure due to the fact that the magnetic head for recording or reproducing data records or reproduces data while being deviated from a target track position due to the width deformation of the magnetic tape during recording or reproduction, or to reduce a frequency of the occurrence of the phenomenon.

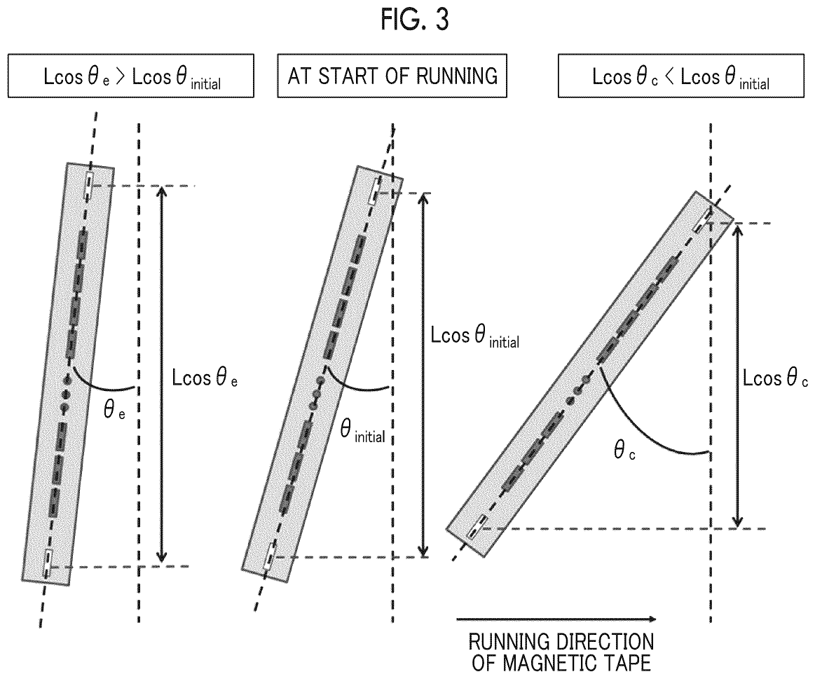

FIG. 3 is an explanatory diagram relating to a change in the angle θ during running of the magnetic tape.

θᵢₙᵢₜᵢₐₗ, which is an angle θ at the start of running, can be set to, for example, 0° or more or more than 0°.

In FIG. 3, the central figure shows a state of the module at the start of running.

In FIG. 3, the right figure shows a state of the module in a case where the angle θ is set to an angle θ_{c}, which is an angle larger than θᵢₙᵢₜᵢₐₗ. The effective distance between the servo signal reading elements Lcosθ_{c} is a value smaller than Lcosθᵢₙᵢₜᵢₐₗ at the start of running of the magnetic tape. In a case where the width of the magnetic tape contracts during running of the magnetic tape, it is preferable to perform such angle adjustment.

On the other hand, in FIG. 3, the left figure shows a state of the module in a case where the angle θ is set to an angle θₑ, which is an angle smaller than θᵢₙᵢₜᵢₐₗ. The effective distance between the servo signal reading elements Lcosθₑ is a value larger than Lcosθᵢₙᵢₜᵢₐₗ at the start of running of the magnetic tape. In a case where the width of the magnetic tape expands during running of the magnetic tape, it is preferable to perform such angle adjustment.

As described above, changing the head tilt angle during running of the magnetic tape can contribute to prevention of the phenomenon such as overwriting of recorded data or reproduction failure due to the fact that the magnetic head for recording or reproducing data records or reproduces data while being deviated from a target track position due to the width deformation of the magnetic tape during recording or reproduction, or can contribute to reduction of the frequency of the occurrence of the phenomenon.

Meanwhile, recording of data on the magnetic tape and reproduction of the recorded data are usually performed by running the magnetic tape to slide the magnetic layer surface and the magnetic head on each other. The present inventor supposed that, in a case where the magnetic tape is made to run with the head tilted during such a recording and/or reproduction, a contact state between the magnetic head and the magnetic layer surface becomes unstable, which can be a factor in decreasing running stability.

Based on the above supposition, the present inventor has made extensive studies. As a result, the present inventor has newly found that the magnetic tape in which the edge portion Rvm, details of which are described below, is −0.55 μm or more and −0.20 μm or less at both edge portions of the magnetic tape can exhibit excellent running stability in a case where the data is recorded and/or reproduced by tilting the head in a high temperature and low humidity environment. The present inventor considers that the edge portion Rvm is a value that can be an index of the depth of the minute cracks generated in the edge portion of the magnetic layer surface. The present inventor supposes that, by suppressing the occurrence of deep microcracks in the edge portion and appropriately allowing shallow cracks to be present, it is possible to suppress the occurrence of flakes called debris by partially peeling the magnetic tape with the cracks present in the edge portion on the magnetic layer surface as a starting point in a case where the head is tilted and the head and the magnetic layer surface slide on each other. The present inventor supposes that the fact that the occurrence of debris can be suppressed contributes to the improvement of running stability since the adhesion of debris to the head is considered to make the contact state between the head and the magnetic layer surface unstable. However, the present invention is not limited by supposition of the present inventor described in the present specification.

In the present specification, the running stability in a case of performing the recording and/or reproducing of data by tilting the head during the running of the magnetic tape in the high temperature and low humidity environment is also simply referred to as “running stability”. In addition, the high temperature and low humidity environment may be, for example, an environment having a temperature of about 30° C. to 50° C. A humidity of the environment may be, for example, about 0% to 30% as a relative humidity. In the present invention and the present specification, the temperature and humidity described for an environment are an atmosphere temperature and a relative humidity of the environment.

### Edge Portion Rvm

In the present invention and the present specification, the edge portion Rvm is obtained by the following method.

Measurement in which one edge of both edges in the tape width direction of the magnetic layer surface of the magnetic tape is included in the visual field for measurement and measurement in which the other edge is included in the visual field for measurement are each performed under the following measurement conditions. Examples of the noncontact optical surface roughness meter include Contour GT-I manufactured by Bruker. The measurement described in the section of Examples described later is a measurement performed using Contour GT-I manufactured by Bruker as a noncontact optical surface roughness meter. In the present invention and the present specification, the term “magnetic layer surface (surface of the magnetic layer)” has the same meaning as the surface of the magnetic tape on the magnetic layer side.

### Measurement Conditions

Environment: temperature 23° C., relative humidity 50%
Device: noncontact optical surface roughness meter
Measurement mode: vertical scan interferometry (VSI)
Objective lens: 50×
Intermediate lens: 2.0×
Angle of visual field for measurement: X axis 48.2 μm×Y axis 36.2 μm
Averaging: 3 times

Direction of sample: The sample is installed and measured such that the longitudinal direction of the magnetic tape is parallel to the X axis in the visual field for measurement.

Method of fixing sample: The sample is fixed by adsorbing the sample on the adsorption layer of the adsorption film not to cover the edge portion, in order to prevent deviation during measurement and floating of the magnetic tape. As the adsorption film, a commercially available adsorption film can be used.

The measurement including one edge of both edges of the magnetic tape in the tape width direction in the visual field for measurement is performed at a total of three measurement points by shifting the position by 5 mm or more in the tape longitudinal direction. The arithmetic average of the average valley depth Rvm acquired for each of three measurement points in a range of 0 μm to 1 μm, with the position of the edge in the tape width direction in the visual field for measurement set to 0 μm, is defined as the edge portion Rvm of one edge portion.

The measurement including the other edge of both edges of the magnetic tape in the tape width direction in the visual field for measurement is also performed at a total of three measurement points by shifting the position by 5 mm or more in the tape longitudinal direction. The arithmetic average of the average valley depth Rvm acquired for each of three measurement points in a range of 0 μm to 1 μm, with the position of the edge in the tape width direction in the visual field for measurement set to 0 μm, is defined as the edge portion Rvm of the other edge portion.

In the data obtained by each of the above measurements, a line without data loss in one line in the tape longitudinal direction (X-axis direction) is defined as an “edge”.

For each measurement point, the software calculates the average valley depth Rvm by performing data processing under the following data processing conditions. Examples of the software that performs the data processing include Vision64 manufactured by Bruker. The edge portion Rvm described in the section of Examples described later is a value obtained by acquiring Rvm by performing data processing for each measurement point using Vision64 manufactured by Bruker as software.

### Data Processing Conditions

Distortion/tilt correction: Tilt Only (Plane Fit)

In the magnetic tape, both an average valley depth Rvm measured at one edge portion of the surface of the magnetic layer and an average valley depth Rvm measured at the other edge portion are −0.55 μm or more and −0.20 μm or less. The edge portion Rvm of one edge portion and the edge portion Rvm of the other edge portion may be the same value or different values as long as both are within a range of −0.55 μm or more and −0.20 μm or less.

From the viewpoint of further improving running stability, the edge portion Rvm of each edge portion is preferably −0.50 μm or more, and more preferably −0.45 μm or more, −0.40 μm or more, and −0.35 μm or more in this order.

In addition, from the viewpoint of further improving running stability, the edge portion Rvm of each edge portion is preferably −0.25 μm or less, and more preferably −0.30 μm or less.

The controller for the edge portion Rvm will be described below.

Hereinafter, the magnetic tape will be described in more detail.

### Magnetic Layer

Ferromagnetic Powder

As a ferromagnetic powder included in the magnetic layer, a well-known ferromagnetic powder as a ferromagnetic powder used in magnetic layers of various magnetic recording media can be used alone or in combination of two or more. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of magnetization stability, the average particle size of the ferromagnetic powder is preferably 5 nm or more, more preferably 8 nm or more, still more preferably 10 nm or more, still more preferably 15 nm or more, and still more preferably 20 nm or more.

### Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite crystal structure in an X-ray diffraction spectrum obtained by X-ray diffraction analysis, it is determined that the hexagonal ferrite crystal structure is detected as the main phase. In a case where only a single structure is detected by X-ray diffraction analysis, this detected structure is taken as the main phase. The hexagonal ferrite crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Note that a rare earth atom is not included in the above divalent metal atom. The term “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a prascodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is one aspect of the hexagonal ferrite powder, will be described in more detail.

The activation volume of the hexagonal strontium ferrite powder is preferably 2500 nm³ or less, more preferably 2300 nm³ or less, and still more preferably 2000 nm³ or less. On the other hand, from the viewpoint of magnetization stability, the activation volume of the hexagonal strontium ferrite powder is, for example, preferably 800 nm³ or more, more preferably 1000 nm³ or more, and still more preferably 1200 nm³ or more. The same applies to an activation volume of the hexagonal barium ferrite powder.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity Hc and an activation volume V, by performing measurement in a coercivity Hc measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

$$Hc = 2 Ku / Ms \{ 1 - {[ ( k T / K u V ) ln ( A t / 0.693 ) ]}^{1 / 2} \}$$

[In the above expression, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom.) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom.) satisfy a ratio of a rare earth atom surface layer portion content/a rare earth atom bulk content >1.0. A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

Moreover, it is supposed that the use of the hexagonal strontium ferrite powder having a rare earth atom surface layer portion uneven distribution property as a ferromagnetic powder in the magnetic layer also contributes to inhibition of a magnetic layer surface from being scraped by being slid with respect to the magnetic head. That is, it is supposed that the hexagonal strontium ferrite powder having a rare earth atom surface layer portion uneven distribution property can also contribute to an improvement of running durability of the magnetic tape. It is supposed that this may be because uneven distribution of rare earth atoms on a surface of a particle constituting the hexagonal strontium ferrite powder contributes to an improvement of interaction between the particle surface and an organic substance (for example, a binding agent and/or an additive) included in the magnetic layer, and, as a result, a strength of the magnetic layer is improved.

From the viewpoint of further suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in a case of including two or more kinds of rare earth atoms is obtained for the total of two or more kinds of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic tape, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Note that the following dissolution conditions such as the amount of sample powder are exemplified, and dissolution conditions for partial dissolution and total dissolution can be employed in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 at % of an iron atom can be obtained. In a case where a plurality of kinds of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic tape, it is desirable that mass magnetization σs of the ferromagnetic powder included in the magnetic tape is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, σs of the hexagonal strontium ferrite powder may be 45 A·m²/kg or more, and may be 47 A·m²/kg or more. On the other hand, from the viewpoint of noise reduction, σs is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 15 kOe. 1 [kOc] is 10⁶/4π[A/m].

Regarding the content (bulk content) of a constituent atom of the hexagonal strontium ferrite powder, a strontium atom content may be, for example, in a range of 2.0 to 15.0 at % with respect to 100 at % of an iron atom. In one aspect, the hexagonal strontium ferrite powder may include only a strontium atom as a divalent metal atom. In another aspect, the hexagonal strontium ferrite powder may include one or more other divalent metal atoms in addition to a strontium atom. For example, a barium atom and/or a calcium atom may be included. In a case where the other divalent metal atoms other than the strontium atom are included, a content of the barium atom and a content of the calcium atom in the hexagonal strontium ferrite powder respectively can be, for example, in a range of 0.05 to 5.0 at % with respect to 100 at % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M-type crystal structure may be detected by X-ray diffraction analysis. For example, M type hexagonal ferrite is represented by a composition formula of AFe₁₂O₁₉. Here, A represents a divalent metal atom, and in a case where the hexagonal strontium ferrite powder is the M type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in one aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

### Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

### ε-Iron Oxide Powder

Preferred specific examples of the ferromagnetic powder include an ε-iron oxide powder. In the present invention and the present specification, the term “¿-iron oxide powder” refers to a ferromagnetic powder in which an ε-iron oxide crystal structure is detected as a main phase by X-ray diffraction analysis. For example, in a case where the highest intensity diffraction peak is attributed to an &-iron oxide crystal structure in an X-ray diffraction spectrum obtained by X-ray diffraction analysis, it is determined that the ε-iron oxide crystal structure is detected as the main phase. As a method of manufacturing an &-iron oxide powder, a manufacturing method from a goethite, a reverse micelle method, and the like are known. All of the manufacturing methods are well known. Regarding a method of manufacturing an &-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Note that the method of manufacturing the &-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for manufacturing a magnetic tape exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the ¿-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving the thermal stability may include the anisotropy constant Ku. The ε-iron oxide powder preferably has Ku of 3.0×10⁴ J/m³ or more, and more preferably has Ku of 8.0×10⁴ J/m³ or more. Ku of the ε-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic tape, it is desirable that mass magnetization σs of the ferromagnetic powder included in the magnetic tape is high. In this regard, in one aspect, σs of the &-iron oxide powder may be 8 A·m²/kg or more, and may be 12 A·m²/kg or more. On the other hand, from the viewpoint of noise reduction, σs of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000× with a transmission electron microscope, the image is printed on photographic printing paper or displayed on a display so that the total magnification of 500000× to obtain an image of particles configuring the powder. A target particle is selected from the obtained image of particles, a contour of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size described in the section of Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic tape in order to measure the particle size, a method disclosed in a paragraph 0015 of JP2011-048878A can be employed, for example.

In the present invention and the present specification, unless otherwise noted, (1) in a case where the shape of the particle observed in the particle image described above is a needle shape, a fusiform shape, or a columnar shape (here, a height is greater than a maximum major diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum major diameter of a plate surface or a bottom surface), the particle size is shown as a maximum major diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %, with respect to the total mass of the magnetic layer. A high filling percentage of the ferromagnetic powder in the magnetic layer is preferable from the viewpoint of improving the recording density.

### Binding Agent

The magnetic tape can be a coating type magnetic tape, and include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below. For the above binding agent, descriptions disclosed in paragraphs 0028 to 0031 of JP2010-24113A can be referred to. In addition, the binding agent may be a radiation curable resin such as an electron beam curable resin. For the radiation curable resin, descriptions disclosed in paragraphs 0044 and 0045 of JP2011-048878A can be referred to.

An average molecular weight of the resin used as the binding agent can be, for example, 10,000 to 200,000 as a weight-average molecular weight. The weight-average molecular weight of the present invention and the present specification is a value obtained by performing polystyrene conversion of a value measured by gel permeation chromatography (GPC) under the following measurement conditions. The weight-average molecular weight described in the section of Examples described below is a value obtained by performing polystyrene conversion of a value measured under the following measurement conditions. The binding agent can be used, for example, in an amount of 1.0 to 30.0 parts by mass and can be preferably used in an amount of 1.0 to 20.0 parts by mass, with respect to 100.0 parts by mass of the ferromagnetic powder.
GPC device: HLC-8120 (manufactured by Tosoh Corporation)
Column: TSK gel Multipore HXL-M (manufactured by Tosoh Corporation, 7.8 mm inner diameter (ID)×30.0 cm)
Eluent: tetrahydrofuran (THF)
Curing agent

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. The curing reaction proceeds in a magnetic layer forming step, whereby at least a part of the curing agent can be included in the magnetic layer in a state of being reacted (crosslinked) with other components such as the binding agent. The same applies to the layer formed using this composition in a case where the composition used to form the other layer includes a curing agent. The preferred curing agent is a thermosetting compound, and polyisocyanate is suitable for this. For details of the polyisocyanate, descriptions disclosed in paragraphs 0124 and 0125 of JP2011-216149A can be referred to. The curing agent can be used in the composition for forming a magnetic layer in an amount of, for example, 0 to 80.0 parts by mass, and preferably 50.0 to 80.0 parts by mass from the viewpoint of improving a strength of the magnetic layer, with respect to 100.0 parts by mass of the binding agent.

### Additive

The magnetic layer may include one or more kinds of additives, as necessary. As the additive, a commercially available product can be appropriately selected and used according to a desired property. Alternatively, a compound synthesized by a well-known method can be used as the additive. The additive can be used in any amount. Examples of the additive include the curing agent described above. In addition, examples of the additive which can be included in the magnetic layer include a non-magnetic powder (for example, an inorganic powder or carbon black), a lubricant, a dispersing agent, a dispersing assistant, an antibacterial agent, an antistatic agent, an antioxidant, and the like. For example, for the lubricant, descriptions disclosed in paragraphs 0030 to 0033, 0035, and 0036 of JP2016-126817A can be referred to. The non-magnetic layer which will be described below may contain a lubricant. For the lubricant that can be contained in the non-magnetic layer, descriptions disclosed in paragraphs 0030, 0031, 0034, 0035, and 0036 of JP2016-126817A can be referred to. For the dispersing agent, descriptions disclosed in paragraphs 0061 and 0071 of JP2012-133837A can be referred to. The dispersing agent may be added to a composition for forming a non-magnetic layer. For the dispersing agent that can be added to the composition for forming a non-magnetic layer, a description disclosed in a paragraph 0061 of JP2012-133837A can also be referred to. In addition, examples of the non-magnetic powder that can be included in the magnetic layer include a non-magnetic powder which can function as an abrasive and a non-magnetic powder (generally also referred to as a “filler”) included in the magnetic layer in order to form appropriate protrusions on the magnetic layer surface for controlling friction characteristics. For example, for the abrasive, descriptions disclosed in paragraphs 0030 to 0032 of JP2004-273070A can be referred to. As the abrasive, it is preferable to use an abrasive having a specific surface area (hereinafter, referred to as a “BET specific surface area”) measured by a Brunauer-Emmett-Teller (BET) method of 14 m²/g or more. From the viewpoint of the dispersibility, it is preferable to use an abrasive having a BET specific surface area of 40 m²/g or less. For the dispersing agent for improving the dispersibility of the abrasive, descriptions disclosed in paragraphs 0017 to 0028 of JP2014-179149A can be referred to.

As one aspect of the filler contained in the magnetic layer, carbon black can be used. A BET specific surface area of carbon black is preferably 10 m²/g or more and more preferably 15 m²/g or more. The BET specific surface area of carbon black is preferably 50 m²/g or less, and more preferably 40 m²/g or less, from the viewpoint of the case of improving the dispersibility. In addition, as another aspect of the filler, colloidal particles can be used. The colloidal particles are preferably inorganic colloidal particles, more preferably inorganic oxide colloidal particles, and still more preferably silica colloidal particles (colloidal silica), from the viewpoint of availability. In the present invention and the present specification, the “colloidal particles” refer to particles which are dispersed without precipitation to generate a colloidal dispersion, in a case where 1 g of the particles is added to 100 mL of at least one organic solvent of methyl ethyl ketone, cyclohexanone, toluene, or ethyl acetate, or a mixed solvent including two or more kinds of the solvent described above at an optional mixing ratio. An average particle size of the colloidal particles may be, for example, 30 to 300 nm, and preferably 40 to 200 nm. The content of the filler in the magnetic layer is preferably 0.1 to 0.8 parts by mass with respect to 100.0 parts by mass of the ferromagnetic powder. The filler is preferably subjected to a dispersion treatment separately from the ferromagnetic powder, and more preferably subjected to a dispersion treatment separately from the abrasive.

The magnetic layer described above can be provided on a surface of the non-magnetic support directly or indirectly through the non-magnetic layer.

### Non-Magnetic Layer

Next, the non-magnetic layer will be described. The above magnetic tape may have a magnetic layer directly on the non-magnetic support, or may have a non-magnetic layer including a non-magnetic powder between the non-magnetic support and the magnetic layer. The non-magnetic powder used for the non-magnetic layer may be an inorganic substance powder (inorganic powder) or an organic substance powder (organic powder). In addition, the carbon black and the like can be used. Examples of the inorganic substance include metal, metal oxide, metal carbonate, metal sulfate, metal nitride, metal carbide, and metal sulfide. The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010⁻²⁴¹¹³A can be referred to. The content (filling percentage) of the non-magnetic powder of the non-magnetic layer is preferably in a range of 50 to 90 mass % and more preferably in a range of 60 to 90 mass %, with respect to the total mass of the non-magnetic layer.

In one aspect, the non-magnetic layer can contain an Fe-based inorganic oxide powder as the non-magnetic powder. In the present invention and the present specification, the term “Fe-based inorganic oxide powder” refers to an inorganic oxide powder containing iron as a constituent element. Specific examples of the Fe-based inorganic oxide powder include an α-iron oxide powder and a goethite powder. In the present invention and the present specification, the term “α-iron oxide powder” refers to a non-magnetic powder in which an α-iron oxide crystal structure is detected as a main phase by X-ray diffraction analysis. The α-iron oxide powder is also generally called Bengala. The average particle volume of the Fe-based inorganic oxide powder contained in the non-magnetic layer may be, for example, 2.0×10⁻⁶ μm³ or less. The average particle volume may be, for example, 1.0×10⁻⁹ μm³ or more or 1.0×10⁻⁸ μm³ or more, or may be smaller than the values exemplified here. In the present invention and the present specification, the average particle volume is a value obtained by the method described in paragraph 0073 of JP2024-84954A.

The non-magnetic layer can include a binding agent, and can also include an additive. For other details of the binding agent or the additive of the non-magnetic layer, a well-known technology regarding the non-magnetic layer can be applied. In addition, in regards to the type and the content of the binding agent, and the type and the content of the additive, for example, the well-known technology regarding the magnetic layer can be applied.

The present inventor considers that the flexibility of the non-magnetic layer can contribute to suppressing the occurrence of deep cracks in the edge portion of the magnetic tape in cutting (slitting) in the manufacturing step of the magnetic tape. In a case where the occurrence of deep cracks in the edge portion of the magnetic tape can be suppressed, the value of the edge portion Rvm can be reduced. Examples of the means for forming the flexible non-magnetic layer include the following means.

Increasing a proportion of carbon black in the non-magnetic powder of the non-magnetic layer. A proportion of the carbon black in the non-magnetic powder of the non-magnetic layer, with respect to the total amount of the non-magnetic powders, may be, for example, 10.0 mass % or greater, 20.0 mass % or greater, 30.0 mass % or greater, 40.0 mass % or greater, 50.0 mass % or greater, 60.0 mass % or greater, 70.0 mass % or greater, 80.0 mass % or greater, and 90.0 mass % or greater, and may also be 100.0 mass % (that is, only carbon black is used as the non-magnetic powder).

Using a binding agent having a low glass transition temperature Tg as the binding agent of the non-magnetic layer. In the present invention and the present specification, the glass transition temperature Tg is determined as the baseline shift start temperature of a heat flow chart at the time of temperature rise from the measurement result of the heat flow measurement using a differential scanning calorimeter. As the binding agent of the non-magnetic layer, for example, a resin having a glass transition temperature Tg of 150° C. or lower, 130° C. or lower, 110° C. or lower, 90° C. or lower, 70° C. or lower, or 50° C. or lower can be used. The glass transition temperature Tg of the resin used as the binding agent of the non-magnetic layer can be, for example, 30° C. or higher or 40° C. or higher, and may be lower than the values exemplified here.

The non-magnetic layer of the magnetic tape also includes a substantially non-magnetic layer including a small amount of ferromagnetic powder as impurities, for example, or intentionally, together with the non-magnetic powder. Here, the substantially non-magnetic layer is a layer having a residual magnetic flux density equal to or smaller than 10 mT, a layer Having a Coercivity Equal to or Smaller than 7.96 kA/m (100 Oe), or a Layer Having a Residual Magnetic Flux Density Equal to or Smaller than 10 mT and a Coercivity Equal to or Smaller than 7.96 kA/m (100 Oe). It is preferable that the non-magnetic layer does not have a residual magnetic flux density and coercivity.

Non-magnetic support

Next, the non-magnetic support will be described. Examples of the non-magnetic support (hereinafter, also simply referred to as a “support”) include well-known components such as polyethylene terephthalate, polyethylene naphthalate, polyamide, polyamideimide, and aromatic polyamide subjected to biaxial stretching. Among these, polyethylene terephthalate, polyethylene naphthalate, and polyamide are preferable. A corona discharge, a plasma treatment, an easy-bonding treatment, or a heat treatment may be performed on these supports in advance.

In one aspect, the non-magnetic support of the magnetic tape can be an aromatic polyester support. In the present invention and the present specification, the term “aromatic polyester” means a resin containing an aromatic skeleton and a plurality of ester bonds, and the “aromatic polyester support” means a support containing at least one aromatic polyester film. The term “aromatic polyester film” refers to a film in which a component that accounts for the largest amount on a mass basis among components constituting the film is an aromatic polyester. The term “aromatic polyester support” in the present invention and the present specification includes those in which all resin films contained in the support are aromatic polyester films, and those containing the aromatic polyester film and another resin film. Specific examples of the aromatic polyester support include a single aromatic polyester film, a laminated film of two or more layers of the aromatic polyester film having the same constituent component, a laminated film of two or more layers of the aromatic polyester film having different constituent components, and a laminated film including one or more layers of the aromatic polyester film and one or more layers of resin film other than the aromatic polyester. An adhesive layer or the like may be optionally included between two adjacent layers in the laminated film. The aromatic polyester support may optionally include a metal film and/or a metal oxide film formed on one or both surfaces by vapor deposition or the like. The same applies to a “polyethylene terephthalate support” and a “polyethylene naphthalate support” in the present invention and the present specification.

An aromatic ring contained in the aromatic skeleton of the aromatic polyester is not particularly limited. Specific examples of the aromatic ring include a benzene ring and a naphthalene ring.

For example, polyethylene terephthalate (PET) is a polyester containing a benzene ring, and is a resin obtained by polycondensing ethylene glycol with terephthalic acid and/or dimethyl terephthalate. The “polyethylene terephthalate” in the present invention and the present specification includes those having a structure having one or more other components (for example, a copolymer component, a component introduced into a terminal or a side chain, or the like) in addition to the above component.

Polyethylene naphthalate (PEN) is a polyester containing a naphthalene ring, and is a resin obtained by performing an esterification reaction between dimethyl 2,6-naphthalenedicarboxylate and ethylene glycol and then performing a transesterification reaction and a polycondensation reaction. The term “polyethylene naphthalate” in the present invention and the present specification includes those having a structure having one or more other components (for example, a copolymer component, a component introduced into a terminal or a side chain, or the like) in addition to the above component.

In addition, in one aspect, the non-magnetic support of the magnetic tape can be an aromatic polyamide support. In the present invention and the present specification, the term “aromatic polyamide” means a resin including an aromatic skeleton and a plurality of amide bonds. An aromatic ring contained in the aromatic skeleton of the aromatic polyamide is not particularly limited. Specific examples of the aromatic ring include a benzene ring. The term “aromatic polyamide support” means a support including at least one layer of aromatic polyamide film. The term “aromatic polyamide film” refers to a film in which a component that accounts for the largest amount on a mass basis among components constituting the film is an aromatic polyamide. The term “aromatic polyamide support” in the present invention and the present specification includes those in which all resin films contained in the support are aromatic polyamide films, and those containing the aromatic polyamide film and another resin film. Specific examples of the aromatic polyamide support include a single aromatic polyamide film, a laminated film of two or more layers of the aromatic polyamide film having the same constituent component, a laminated film of two or more layers of the aromatic polyamide film having different constituent components, and a laminated film including one or more layers of the aromatic polyamide film and one or more layers of resin film other than the aromatic polyamide. An adhesive layer or the like may be optionally included between two adjacent layers in the laminated film. The aromatic polyamide support may optionally include a metal film and/or a metal oxide film formed on one or both surfaces by vapor deposition or the like.

In addition, as described above, the non-magnetic support may be a biaxially stretched film, and may be a film that has been subjected to corona discharge, a plasma treatment, an easy-bonding treatment, a heat treatment, or the like.

As an index of the physical properties of the non-magnetic support, for example, a moisture content can be used. In the present invention and the present specification, a moisture content of the non-magnetic support is a value obtained by the following method.

A sample piece (for example, a sample piece having a mass of a few grams) cut out from the non-magnetic support of which the moisture content is to be measured is dried in a vacuum dryer at a temperature of 180° C. and a pressure of 100 Pascal (Pa) or less until the sample piece has a constant weight. A mass of the sample piece thus dried is defined as W1. W1 is a value measured in a measurement environment of a temperature of 23° C. and a relative humidity of 50% within 30 seconds after the sample piece is taken out from the vacuum dryer. Next, a mass of this sample piece after being left under an environment of a temperature of 25° C. and a relative humidity of 75% for 48 hours is defined as W2. W2 is a value measured in a measurement environment of a temperature of 23° C. and a relative humidity of 50% within 30 seconds after the sample piece is taken out from the environment. The moisture content is calculated by the following equation.

$$Moisture content ( \% ) = [ ( W 2 - W 1 ) / W 1 ] \times 100$$

For example, after removing portions, such as the magnetic layer, other than the non-magnetic support from the magnetic tape by a well-known method (for example, film removal using an organic solvent), the moisture content of the non-magnetic support can be obtained by the above method.

In one aspect, the above-described non-magnetic support of the magnetic tape preferably has a moisture content of 2.0% or less, more preferably 1.8% or less, still more preferably 1.6% or less, even more preferably 1.4% or less, further preferably 1.2% or less, and still further more preferably 1.0% or less. In addition, the moisture content of the non-magnetic support of the magnetic tape may be 0%, 0% or more, more than 0%, or 0.1% or more.

Examples of an index of physical properties of the non-magnetic support also include a young's modulus. In the present invention and the present specification, the young's modulus of the non-magnetic support is a value to be measured by the following method in a measurement environment with a temperature of 23° C. and a relative humidity of 50%.

A sample piece cut out from the non-magnetic support to be measured is pulled by a universal tensile test device under the conditions of a distance between chucks of 100 mm, a tensile speed of 10 mm/min, and a chart speed of 500 mm/min. As the universal tensile test device, for example, a commercially available universal tensile test device such as Tensilon manufactured by Toyo Baldwin Co., Ltd. or a universal tensile test device having a known configuration can be used. Young's moduli in a longitudinal direction and a width direction of the sample piece are calculated from a tangent line of a rising portion of a load-elongation curve thus obtained. Here, the longitudinal direction and the width direction of the sample piece mean a longitudinal direction and a width direction in a case where the sample piece is included in the magnetic tape.

For example, after removing portions, such as the magnetic layer, other than the non-magnetic support from the magnetic tape by a well-known method (for example, film removal using an organic solvent), the young's moduli in the longitudinal direction and the width direction of the non-magnetic support can be obtained by the above method.

In one aspect, the young's modulus of the non-magnetic support of the magnetic tape in the longitudinal direction is preferably 3000 MPa or more, more preferably 4000 MPa or more, still more preferably 5000 MPa or more, and still more preferably 6000 MPa or more. In addition, the young's modulus of the non-magnetic support of the magnetic tape in the longitudinal direction may be 15000 MPa or less, 13000 MPa or less, or 12000 MPa or less. Regarding the width direction, the young's modulus of the non-magnetic support of the magnetic tape in the width direction is preferably 2000 MPa or more, more preferably 3000 MPa or more, still more preferably 4000 MPa or more, and still more preferably 5000 MPa or more. In addition, the young's modulus of the non-magnetic support of the magnetic tape in the width direction may be 12000 MPa or less, 11000 MPa or less, or 10000 MPa or less. In a case where the magnetic tape is manufactured, the non-magnetic support is usually used in a machine direction (MD direction) as the longitudinal direction and a transverse direction (TD direction) as the width direction of the film. Further, in one aspect, the young's modulus in the longitudinal direction is preferably larger than the young's modulus in the width direction, and a difference (the young's modulus in the longitudinal direction—the young's modulus in the width direction) is more preferably in the range of 800 MPa to 3000 MPa.

The moisture content and the young's modulus of the non-magnetic support can be controlled by the types and mixing ratios of the components constituting the support, the manufacturing conditions of the support, and the like. For example, the young's modulus in the longitudinal direction and the young's modulus in the width direction can be controlled respectively by adjusting a stretching ratio in each direction in a biaxial stretching treatment.

### Back Coating Layer

The magnetic tape may or may not have a back coating layer including a non-magnetic powder on a surface side of the non-magnetic support opposite to a surface side having the magnetic layer. The back coating layer preferably contains one or both of carbon black and an inorganic powder. The back coating layer can include a binding agent, and can also include an additive. For details of the non-magnetic powder, the binding agent, and the additive of the back coating layer, a well-known technology regarding the back coating layer can be applied, and a well-known technology regarding the magnetic layer and/or the non-magnetic layer can be applied. For example, for the back coating layer, descriptions disclosed in paragraphs 0018 to 0020 of JP2006-331625A and Page 4, Line 65, to Page 5, Line 38, of U.S. Pat. No. 7,029,774B can be referred to.

### Various Thicknesses

Regarding a tape thickness (total thickness) of the magnetic tape, it has been required to increase the recording capacity (increase the capacity) of the magnetic tape with the enormous increase in the amount of information in recent years. For example, as means for increasing the capacity, a thickness of the magnetic tape may be reduced to increase a length of the magnetic tape accommodated in one roll of a magnetic tape cartridge. From this point, the tape thickness (total thickness) of the magnetic tape is preferably 5.6 μm or less, and more preferably 5.5 μm or less, 5.4 μm or less, 5.3 μm or less, 5.2 μm or less, 5.1 μm or less, and 5.0 μm or less in this order. In addition, from the viewpoint of case of handling, the tape thickness of the magnetic tape is preferably 3.0 μm or more, and more preferably 3.5 μm or more.

The tape thickness (total thickness) of the magnetic tape can be measured by the following method.

Ten measurement samples (for example, 5 to 10 cm in length) are cut out from any part of the magnetic tape, and these measurement samples are stacked to measure the thickness. A value (thickness per measurement sample) obtained by dividing the measured thickness by 1/10 is defined as the tape thickness. The thickness measurement can be performed using a well-known measuring instrument capable of measuring a thickness on the order of 0.1 μm. A thickness of the non-magnetic support is preferably 3.0 to 5.0 μm.

A thickness of the magnetic layer can be optimized according to a saturation magnetization amount of a magnetic head used, a head gap length, a band of a recording signal, and the like, and is generally 0.01 μm to 0.15 μm, and, from the viewpoint of high-density recording, the thickness is preferably 0.02 μm to 0.12 μm and more preferably 0.03 μm to 0.1 μm. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, preferably 0.1 to 1.0 μm, and more preferably 0.1 to 0.7 μm.

A thickness of the back coating layer is preferably 0.9 μm or less and more preferably 0.1 to 0.7 μm.

Various thicknesses such as the thickness of the magnetic layer and the like can be obtained by the following method.

A cross section of the magnetic tape in a thickness direction is exposed by an ion beam, and then the exposed cross section is subjected to cross-sectional observation using a scanning electron microscope or a transmission electron microscope. Various thicknesses can be obtained as an arithmetic average of thicknesses obtained at two optional points in the cross-sectional observation. Alternatively, the various thicknesses can be obtained as a designed thickness calculated according to manufacturing conditions.

### Manufacturing Method

### Preparation of Composition for Forming Each Layer

A composition for forming the magnetic layer, the non-magnetic layer, or the back coating layer usually includes a solvent together with the various components described above. As a solvent, various organic solvents generally used for manufacturing a coating type magnetic recording medium can be used. Among these, from the viewpoint of solubility of the binding agent usually used in the coating type magnetic recording medium, a composition for forming each layer preferably includes one or more ketone solvents such as acetone, methyl ethyl ketone, methyl isobutyl ketone, diisobutyl ketone, cyclohexanone, isophorone, and tetrahydrofuran. The amount of the solvent in the composition for forming each layer is not particularly limited, and can be set to the same as that of the composition for forming each layer of a typical coating type magnetic recording medium. In addition, a step of preparing the composition for forming each layer can usually include at least a kneading step, a dispersing step, and a mixing step provided before and after these steps, as necessary. Each step may be divided into two or more stages. Components used for the preparation of composition for forming each layer may be added at an initial stage or in a middle stage of each step. Each component may be separately added in two or more steps. For example, a binding agent may be added separately in a kneading step, a dispersing step, and a mixing step for adjusting a viscosity after dispersion. In addition, the filtering may be performed after the dispersion treatment. For the filter used for the filtering, the following description can be referred to.

In the manufacturing step of the magnetic tape, a well-known manufacturing technology in the related art can be used in a part or all of the steps. In the kneading step, an open kneader, a continuous kneader, a pressure kneader, or a kneader having a strong kneading force such as an extruder is preferably used. Details of the kneading treatment are described in JP1989-106338A (JP-H01-106338A) and JP1989-79274A (JP-H01-79274A). In addition, in order to disperse the composition for forming each layer, glass beads and/or other beads can be used. As such dispersion beads, zirconia beads, titania beads, and steel beads which are dispersion beads having a high specific gravity are suitable. These dispersion beads are preferably used by optimizing a particle diameter (bead diameter) and filling percentage. As a disperser, a well-known disperser can be used. The composition for forming each layer may be filtered by a well-known method before performing the coating step. The filtering can be performed by using a filter, for example. As the filter used in the filtering, a filter having a pore diameter of 0.01 to 3 μm (for example, a filter made of glass fiber or a filter made of polypropylene) can be used, for example.

### Coating Step

The magnetic layer can be formed, for example, by directly applying the composition for forming a magnetic layer onto the non-magnetic support or performing multilayer applying of the composition for forming a magnetic layer with the composition for forming a non-magnetic layer sequentially or simultaneously. In a case of performing an alignment treatment, the alignment treatment is performed on a coating layer of the composition for forming a magnetic layer in an alignment zone while the coating layer is in a wet state. For the alignment treatment, various well-known technologies including a description disclosed in a paragraph 0052 of JP2010⁻²⁴¹¹³A can be used. For example, a vertical alignment treatment can be performed by a well-known method such as a method using a polar opposing magnet. In the alignment zone, a drying speed of the coating layer can be controlled depending on a temperature of dry air and an air volume and/or a transportation speed in the alignment zone. Further, the coating layer may be preliminarily dried before the transportation to the alignment zone.

The back coating layer can be formed by applying a composition for forming a back coating layer onto a side of the non-magnetic support opposite to a side having the magnetic layer (or to be provided with the magnetic layer).

For details of the coating for forming each layer, a description disclosed in a paragraph 0066 of JP2010⁻²³¹⁸⁴³A can be referred to.

### Other Steps

After the above-described coating step, a calendering treatment is usually performed in order to improve the surface smoothness of the magnetic tape. For calendering conditions, a calender pressure (linear pressure) is, for example, 200 to 500 kN/m, preferably 250 to 350 kN/m, a calender temperature (surface temperature of calender roll) is preferably 80° C. to 95° C., and a calender speed is, for example, 50 to 300 m/min, and preferably 80 to 200 m/min.

After the calendering treatment, the magnetic tape before the following cutting (slitting) can be subjected to a heat treatment. Regarding the heat treatment conditions, for example, an atmosphere temperature (hereinafter, also referred to as a “heating temperature”) of an atmosphere in which the heat treatment is performed is, for example, 35° C. to 100° C., and preferably 50° C. to 80° C. The heat treatment time is, for example, 12 to 72 hours and preferably 24 to 48 hours. The present inventor considers that the lower the heating temperature, the more flexible the non-magnetic layer after the heat treatment, and the smaller the value of the edge portion Rvm. In addition, the present inventor considers that the shorter the heat treatment time, the more flexible the non-magnetic layer after the heat treatment, and the smaller the value of the edge portion Rvm.

For other various steps for manufacturing the magnetic tape, descriptions disclosed in paragraphs 0067 to 0070 of JP2010⁻²³¹⁸⁴³A can be referred to.

Through various steps, a long magnetic tape original roll can be obtained. The obtained magnetic tape original roll is cut (slit) by a well-known cutter, for example, to have a width of the magnetic tape to be accommodated in the magnetic tape cartridge. The width can be determined according to the standard, and is usually ½ inches. 1 inch=2.54 cm.

A servo pattern is usually formed on the magnetic tape obtained by slitting.

### Formation of Servo Pattern

The term “formation of servo pattern” can also be referred to as “recording of servo signal”. The formation of the servo pattern will be described below.

The servo pattern is usually formed along a longitudinal direction of the magnetic tape. Examples of control (servo control) systems using a servo signal include a timing-based servo (TBS), an amplitude servo, and a frequency servo.

As shown in a European computer manufacturers association (ECMA)-319 (June 2001), a magnetic tape conforming to a linear tape-open (LTO) standard (generally called “LTO tape”) employs a timing-based servo system. In this timing-based servo system, the servo pattern is formed by continuously arranging a plurality of pairs of non-parallel magnetic stripes (also referred to as “servo stripes”) in the longitudinal direction of the magnetic tape. In the present invention and the present specification, the term “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

In a method of uniquely specifying the servo band, a staggered method as shown in ECMA-319 (June 2001) is used. In this staggered method, a group of pairs of non-parallel magnetic stripes (servo stripes) arranged continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps can be transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) crasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two additional methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

### Vertical Squareness Ratio

In one aspect, the vertical squareness ratio of the magnetic tape, may be, for example, 0.55 or more, and from the viewpoint of improving the electromagnetic conversion characteristics, the vertical squareness ratio is preferably 0.60 or more, and more preferably 0.65 or more. In principle, the upper limit of the squareness ratio is 1.00 or less. The vertical squareness ratio of the magnetic tape may be 1.00 or less, 0.95 or less, 0.90 or less, 0.85 or less, or 0.80 or less. From the viewpoint of improving the electromagnetic conversion characteristics, a large value of the vertical squareness ratio of the magnetic tape is preferable. The vertical squareness ratio of the magnetic tape can be controlled by a well-known method such as performing a vertical alignment treatment.

In the present invention and the present specification, the term “vertical squareness ratio” refers to a squareness ratio measured in the vertical direction of the magnetic tape. The term “vertical direction” described regarding the squareness ratio refers to a direction orthogonal to the magnetic layer surface, and can also be referred to as a thickness direction. In the present invention and the present specification, the vertical squareness ratio is obtained by the following method.

A measurement sample having a size capable of being introduced into a vibrating sample magnetometer is cut out from the magnetic tape to be measured. For this measurement sample, using a vibrating sample magnetometer, a magnetic field is applied in the vertical direction (direction orthogonal to the magnetic layer surface) of the measurement sample at a maximum applied magnetic field of 3979 kA/m, a measurement temperature of 296 K, and a magnetic field sweeping speed of 8.3 kA/m/sec, and the magnetization strength of the measurement sample with respect to the applied magnetic field is measured. The measured value of the magnetization strength is obtained as a value after demagnetic field correction and as a value obtained by subtracting the magnetization of a sample probe of the vibrating sample magnetometer as a background noise. Assuming that the magnetization strength at the maximum applied magnetic field is Ms and the magnetization strength at zero applied magnetic field is Mr, a squareness ratio SQ is a value calculated as SQ=Mr/Ms. The measurement temperature refers to the temperature of the measurement sample, and by setting an atmosphere temperature around the measurement sample to the measurement temperature, the temperature of the measurement sample can be set to the measurement temperature by establishing a temperature equilibrium.

### Magnetic Tape Cartridge

Another aspect of the present invention relates to a magnetic tape cartridge comprising the magnetic tape described above.

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic tape apparatus for recording and/or reproducing data on the magnetic tape, the magnetic tape is pulled out of the magnetic tape cartridge to be wound around the reel on the magnetic tape apparatus side. A magnetic head is arranged on a magnetic tape transportation path from the magnetic tape cartridge to a winding reel. Feeding and winding of the magnetic tape are performed between a reel (supply recl) on the magnetic tape cartridge side and a reel (winding reel) on the magnetic tape apparatus side. During this time, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge.

In one aspect, the magnetic tape cartridge may include a cartridge memory. The cartridge memory can be, for example, a non-volatile memory, and head tilt angle adjustment information is already recorded or the head tilt angle adjustment information is recorded. The head tilt angle adjustment information is information for adjusting the head tilt angle during running of the magnetic tape in the magnetic tape apparatus. For example, as the head tilt angle adjustment information, the value of the servo band interval at each position in the longitudinal direction of the magnetic tape during data recording can be recorded. For example, in a case of reproducing the data recorded on the magnetic tape, the value of the servo band interval can be measured during reproduction, and the head tilt angle can be changed by a control device of the magnetic tape apparatus such that the absolute value of the difference from the servo band interval during recording at the same longitudinal position recorded in the cartridge memory approaches zero. The head tilt angle may be, for example, the angle θ described above. In a case where the data is recorded and/or reproduced by tilting the head, the angle θ described above can be more than 0°, 45° or less, 40° or less, or 35° or less.

The magnetic tape and the magnetic tape cartridge can be suitably used in a magnetic tape apparatus (in other words, a magnetic recording and reproducing system) that records and/or reproduces data by changing the head tilt angle during running of the magnetic tape. In such a use form, since a period in which the head is tilted is included during recording and/or reproduction of data, a magnetic tape having high running stability in a case where data is recorded and/or reproduced by tilting the head is preferable.

However, the magnetic tape and the magnetic tape cartridge are not limited to those used in such a magnetic tape apparatus. There is also a use form, for example, in which the head tilt angle in one recording or reproduction and the head tilt angle in subsequent recording or reproduction are changed, and then the head tilt angle is fixed without changing the head tilt angle during each recording or during each reproduction. Even in such a use form, since a period of tilting the head is included during recording and/or reproduction of data, a magnetic tape having high running stability in a case of recording and/or reproducing data by tilting the head is preferable.

### Magnetic Tape Apparatus

Still another aspect of the present invention relates to a magnetic tape apparatus including the magnetic tape described above. In the magnetic tape apparatus, recording of data on the magnetic tape and/or reproduction of data recorded on the magnetic tape can be performed, for example, as the magnetic layer surface of the magnetic tape and the magnetic head come into contact with each other to be slid on each other. The magnetic tape apparatus can attachably and detachably include the magnetic tape cartridge according to one aspect of the present invention.

The magnetic tape cartridge can be mounted on the magnetic tape apparatus comprising the magnetic head and used for recording and/or reproducing data. In the present invention and the present specification, the term “magnetic tape apparatus” means an apparatus capable of performing at least one of the recording of data on the magnetic tape or the reproduction of data recorded on the magnetic tape. Such an apparatus is generally called a drive.

### Magnetic Head

The magnetic tape apparatus may include a magnetic head. The configuration of the magnetic head and the angle θ, which is the head tilt angle, are as described above with reference to FIGS. 1 to 3. The magnetic head included in the magnetic tape apparatus can be an LTO 8 head in one aspect, can be an LTO head of another generation in another aspect, and can be a magnetic head other than the LTO head in another aspect. In a case where the magnetic head includes a reproducing element, a magnetoresistive (MR) element capable of sensitively reading information recorded on the magnetic tape is preferable as the reproducing element. As the MR element, various well-known MR elements (for example, a giant magnetoresistive (GMR) element and a tunnel magnetoresistive (TMR) element) can be used. Hereinafter, a magnetic head that records data and/or reproduces recorded data will also be referred to as a “recording and reproducing head”. An element for recording data (recording element) and an element for reproducing data (reproducing element) are collectively referred to as a “magnetic head element”.

In a case of recording data and/or reproducing recorded data, first, tracking using the servo signal can be performed. That is, by causing the servo signal reading element to follow a predetermined servo track, the magnetic head element can be controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

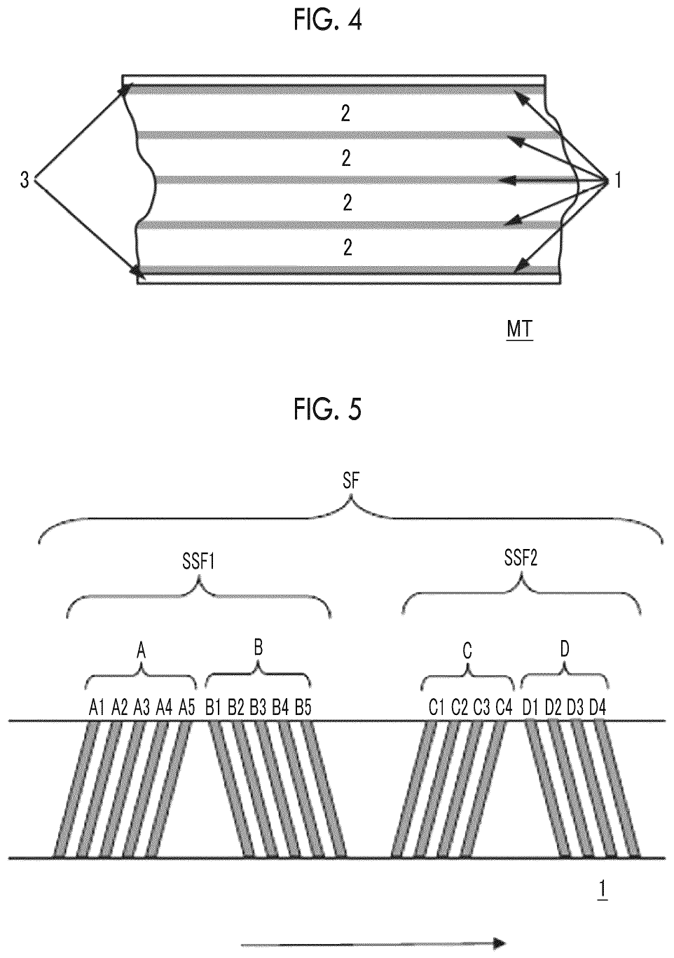

FIG. 4 shows an arrangement example of data bands and servo bands. In FIG. 4, a plurality of servo bands I are arranged to be interposed between guide bands 3 in a magnetic layer of a magnetic tape MT. A plurality of regions 2 interposed between two servo bands are data bands. The servo pattern is a magnetization region, and is formed by magnetizing a specific region of the magnetic layer by the servo write head. A region magnetized by the servo write head (a position where the servo pattern is formed) is determined by the standard. For example, in an LTO Ultrium format tape which is based on a local standard, a plurality of servo patterns inclined with respect to a tape width direction as shown in FIG. 5 are formed on a servo band, in a case of manufacturing a magnetic tape. Specifically, in FIG. 5, a servo frame SF on the servo band 1 is composed of a servo sub-frame 1 (SSF1) and a servo sub-frame 2 (SSF2). The servo sub-frame 1 is composed of an A burst (in FIG. 5, reference sign A) and a B burst (in FIG. 5, reference sign B). The A burst is composed of servo patterns A1 to A5 and the B burst is composed of servo patterns B1 to B5. Meanwhile, the servo sub-frame 2 is composed of a C burst (in FIG. 5, reference sign C) and a D burst (in FIG. 5, reference sign D). The C burst is composed of servo patterns C1 to C4 and the D burst is composed of servo patterns D1 to D4. Such 18 servo patterns are arranged in the sub-frames in an array of 5, 5, 4, 4, as the sets of 5 servo patterns and 4 servo patterns, and are used for identifying the servo frames. FIG. 5 shows one servo frame for description. Note that, in practice, a plurality of the servo frames are arranged in the running direction in each servo band in the magnetic layer of the magnetic tape on which the head tracking of the timing-based servo system is performed. In FIG. 5, the arrow indicates the running direction of the magnetic tape. For example, an LTO Ultrium format tape usually has 5000 or more servo frames per 1 m of tape length in each servo band of the magnetic layer.

In the magnetic tape apparatus, the head tilt angle can be changed during running of the magnetic tape in the magnetic tape apparatus. The head tilt angle is, for example, an angle θ formed by the axis of the element array with respect to the width direction of the magnetic tape. The angle θ is as described above. For example, by providing the recording and reproducing head unit of the magnetic head with an angle adjustment unit for adjusting the angle of the module of the magnetic head, the angle θ can be variably adjusted during running of the magnetic tape. Such an angle adjustment unit can include, for example, a rotation mechanism for rotating the module. A well-known technology can be applied to the angle adjustment unit.

Regarding the head tilt angle during running of the magnetic tape, in a case where the magnetic head includes a plurality of modules, it is possible to specify the angle θ described with reference to FIGS. 1 to 3 for randomly selected modules. θᵢₙᵢₜᵢₐₗ, which is an angle θ at the start of running of the magnetic tape, can be set to 0° or more or more than 0°. This is preferable in terms of adjustment ability to adjust the effective distance between the servo signal reading elements in response to the dimension change in the width direction of the magnetic tape, because the larger θᵢₙᵢₜᵢₐₗ, the larger the amount of change in the effective distance between the servo signal reading elements with respect to the amount of change in the angle θ. From this point, θᵢₙᵢₜᵢₐₗ is preferably 1° or more, more preferably 5° or more, and still more preferably 10° or more. On the other hand, for an angle (generally referred to as “wrap angle”) formed between the magnetic layer surface and the contact surface of the magnetic head in a case where the magnetic tape runs and comes into contact with the magnetic head, it is effective to keep the deviation with respect to the tape width direction small in order to improve the uniformity in the tape width direction of the friction generated by the contact between the magnetic head and the magnetic tape during running of the magnetic tape. In addition, it is desirable to increase the uniformity of the friction in the tape width direction from the viewpoint of the position followability and the running stability of the magnetic head. From the viewpoint of reducing the deviation of the wrap angle in the tape width direction, θᵢₙᵢₜᵢₐₗ is preferably 45° or less, more preferably 40° or less, and still more preferably 35° or less.

Regarding the change in angle θ during running of the magnetic tape, in a case where the angle θ of the magnetic head changes from θᵢₙᵢₜᵢₐₗ at the start of running while the magnetic tape runs in the magnetic tape apparatus for the recording of data on the magnetic tape and/or for the reproduction of data recorded on the magnetic tape, the maximum change amount αθ of the angle θ during the running of the magnetic tape is the larger value between Δθₘₐₓ and Δθₘᵢₙ calculated by the following equation. The maximum value of the angle θ during running of the magnetic tape is θₘₐₓ, and the minimum value is θₘᵢₙ. Note that “max” is an abbreviation for maximum, and “min” is an abbreviation for minimum.

$$Δ {θ}_{ma x} = {θ}_{ma x} - {θ}_{initial}$$

$${Δθ}_{m i n} = {θ}_{i nitial} - {θ}_{m i n}$$

In one aspect, Δθ may be more than 0.000°, and, from the viewpoint of the adjustment ability to adjust the effective distance between the servo signal reading elements in response to the dimension change in the width direction of the magnetic tape, Δθ is preferably 0.001° or more and more preferably 0.010° or more. From the viewpoint of easiness of ensuring synchronization of the recorded data and/or the reproduced data between a plurality of magnetic head elements during the recording and/or reproduction of the data, Δθ is preferably 1.000° or less, more preferably 0.900° or less, still more preferably 0.800° or less, still more preferably 0.700° or less, and still more preferably 0.600° or less.

In the example shown in FIG. 2 and FIG. 3, the axis of the element array is tilted in the running direction of the magnetic tape. Note that the present invention is not limited to such an example. In the above-described magnetic tape apparatus, an embodiment in which the axis of the element array is tilted in a direction opposite to the running direction of the magnetic tape is also included in the present invention.

θᵢₙᵢₜᵢₐₗ, which is the head tilt angle at the start of running of the magnetic tape, can be set by a control device of the magnetic tape apparatus or the like.

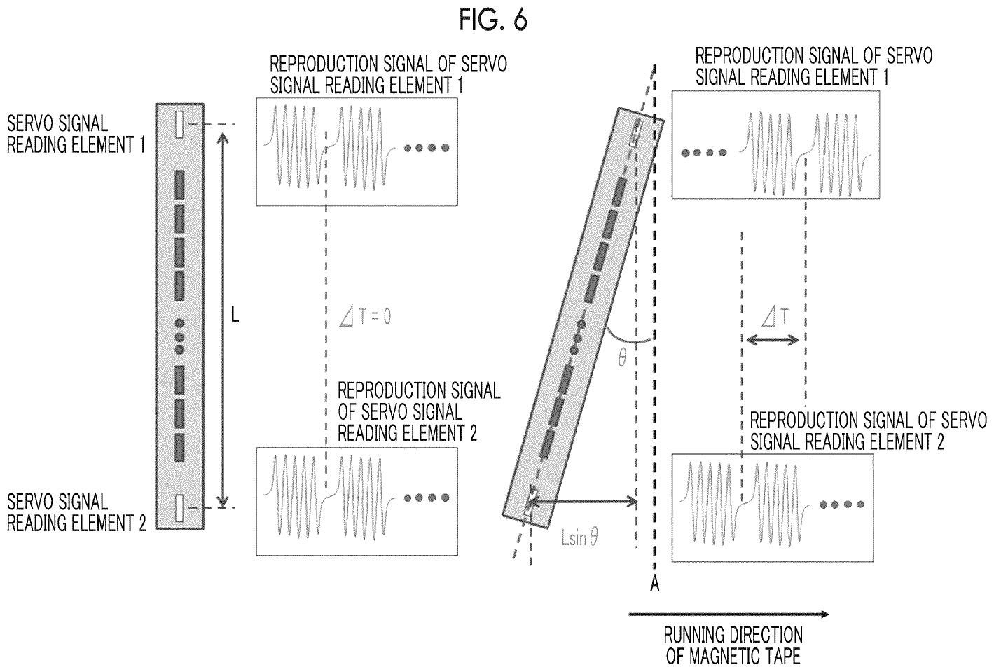

Regarding the head tilt angle during running of the magnetic tape, FIG. 6 is an explanatory diagram of a measuring method of the angle θ during running of the magnetic tape. The angle θ during running of the magnetic tape can be obtained, for example, by the following method. In a case where the angle θ during running of the magnetic tape is obtained by the following method, the angle θ is changed in a range of 0° to 90° during running of the magnetic tape. That is, in a case where the axis of the element array is tilted in the running direction of the magnetic tape at the start of running of the magnetic tape, the element array is not tilted such that the axis of the element array is tilted in the direction opposite to the running direction of the magnetic tape at the start of running of the magnetic tape, during running of magnetic tape, and in a case where the axis of the element array is tilted in the direction opposite to the running direction of the magnetic tape at the start of running of the magnetic tape, the element array is not tilted such that the axis of the element array is tilted in the running direction of the magnetic tape at the start of running of the magnetic tape, during running of the magnetic tape.

A phase difference (that is, a time difference) ΔT between the reproduction signals of the pair of servo signal reading elements 1 and 2 is measured. The measurement of ΔT can be performed by a measurement unit provided in the magnetic tape apparatus. A configuration of such a measurement unit is well-known. The distance L between the central portion of the servo signal reading element 1 and the central portion of the servo signal reading element 2 can be measured by an optical microscope or the like. In a case where the running speed of the magnetic tape is a speed ν, the distance between the central portions of the two servo signal reading elements in the running direction of the magnetic tape is Lsinθ, and a relationship of Lsinθ=v×ΔT is established. Therefore, the angle θ during running of the magnetic tape can be calculated by the equation “θ=arcsin(vΔT/L)”. The right figure of FIG. 6 shows an example in which the axis of the element array is tilted in the running direction of the magnetic tape. In this example, the phase difference (that is, the time difference) ΔT of the phase of the reproduction signal of the servo signal reading element 2 with respect to the phase of the reproduction signal of the servo signal reading element 1 is measured. In a case where the axis of the element array is tilted in the direction opposite to the running direction of the magnetic tape, θ can be obtained by the above-described method except for a point where ΔT is measured as the phase difference (that is, the time difference) of the phase of the reproduction signal of the servo signal reading element 1 with respect to the phase of the reproduction signal of the servo signal reading element 2.

A pitch suitable for a measurement pitch of the angle θ, that is, a measurement interval of the angle θ in the tape longitudinal direction can be selected according to a frequency of the tape width deformation in the tape longitudinal direction. As an example, the measurement pitch can be set to, for example, 250 μm.

### Configuration of Magnetic Tape Apparatus

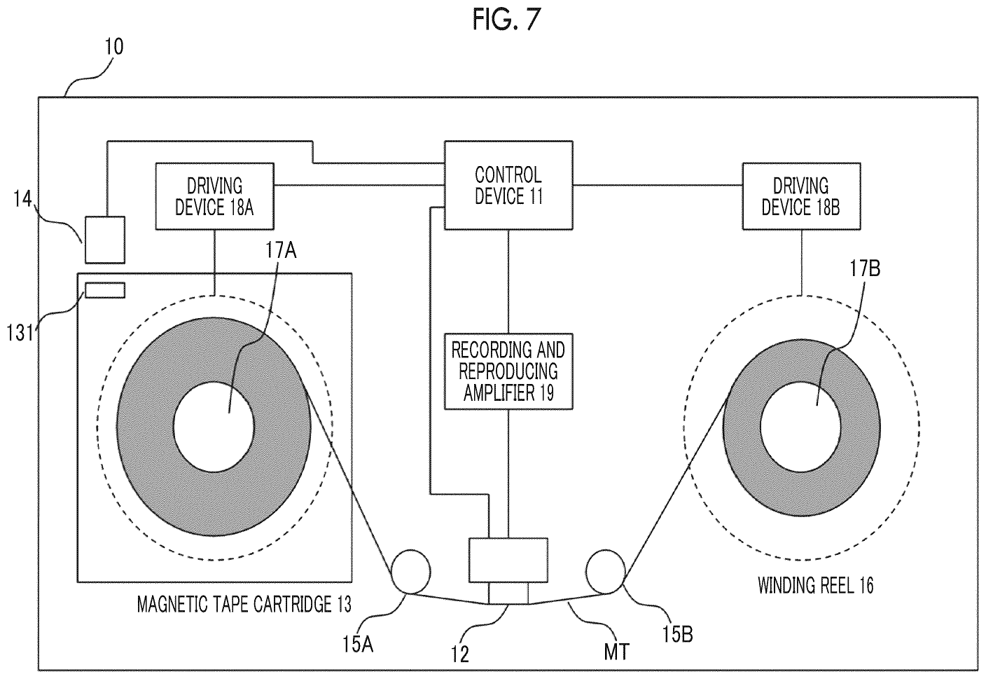

A magnetic tape apparatus 10 shown in FIG. 7 controls a recording and reproducing head unit 12 in accordance with an instruction from a control device 11, and records and reproduces data on a magnetic tape MT.

The magnetic tape apparatus 10 has a configuration capable of detecting and adjusting the tension applied in the longitudinal direction of the magnetic tape from spindle motors 17A and 17B for controlling rotation of a magnetic tape cartridge reel and a winding reel and driving devices 18A and 18B thereof.

The magnetic tape apparatus 10 has a configuration capable of loading a magnetic tape cartridge 13.

The magnetic tape apparatus 10 has a cartridge memory reading and writing device 14 capable of reading and writing a cartridge memory 131 in the magnetic tape cartridge 13.

From the magnetic tape cartridge 13 mounted on the magnetic tape apparatus 10, an end part or a leader pin of the magnetic tape MT is pulled out by an automatic loading mechanism or a manual operation, and the magnetic layer surface of the magnetic tape MT passes on the recording and reproducing head through guide rollers 15A and 15B in a direction contacting with a recording and reproducing head surface of the recording and reproducing head unit 12, and thus the magnetic tape MT is wound around a winding reel 16.

The rotation and torque of the spindle motor 17A and the spindle motor 17B are controlled by a signal from the control device 11, and the magnetic tape MT is run at any speed and tension. A servo pattern formed in advance on the magnetic tape can be used for a control of the tape speed and a control of the head tilt angle. In order to detect the tension, a tension detecting mechanism may be provided between the magnetic tape cartridge 13 and the winding reel 16. The tension may be controlled by using the guide rollers 15A and 15B in addition to the control by the spindle motors 17A and 17B.

The cartridge memory reading and writing device 14 is configured to be capable of reading out and writing information in the cartridge memory 131 in response to an instruction from the control device 11. As a communication method between the cartridge memory reading and writing device 14 and the cartridge memory 131, for example, an international organization for standardization (ISO) 14443 method can be employed.

The control device 11 includes, for example, a controller, a storage unit, a communication unit, and the like.

The recording and reproducing head unit 12 includes, for example, a recording and reproducing head, a servo tracking actuator that adjusts a position of the recording and reproducing head in the track width direction, a recording and reproducing amplifier 19, a connector cable for connection with the control device 11, and the like. The recording and reproducing head includes, for example, a recording element for recording data on the magnetic tape, a reproducing element for reproducing data on the magnetic tape, and a servo signal reading element for reading a servo signal recorded on the magnetic tape. For example, one or more recording elements, reproducing elements, and servo signal reading elements are mounted in one magnetic head. Alternatively, each element may be separately provided in a plurality of magnetic heads according to the running direction of the magnetic tape.

The recording and reproducing head unit 12 is configured to be capable of recording data on the magnetic tape MT in response to an instruction from the control device 11. In addition, the recording and reproducing head unit 12 is configured to be capable of reproducing the data recorded on the magnetic tape MT in response to an instruction from the control device 11.

The control device 11 has a mechanism for obtaining the running position of the magnetic tape from the servo signal read from the servo band in a case where the magnetic tape MT is run, and controlling the servo tracking actuator such that the recording element and/or the reproducing element is located at a target running position (track position). The track position is controlled by feedback control, for example. The control device 11 has a mechanism for obtaining a servo band interval from servo signals read from two adjacent servo bands in a case where the magnetic tape MT is run. The control device 11 can store the obtained information on the servo band interval in the storage unit inside the control device 11, the cartridge memory 131, an external connection device, or the like. In addition, the control device 11 can change the head tilt angle according to the dimension information in the width direction of the magnetic tape during running. Accordingly, the effective distance between the servo signal reading elements can be made to approximate to or match with the interval between the servo bands. The dimension information can be acquired by using a servo pattern formed in advance on the magnetic tape. For example, in this way, during running of the magnetic tape in the magnetic tape apparatus, the angle θ formed by the axis of the element array with respect to the width direction of the magnetic tape can be changed according to the dimension information in the width direction of the magnetic tape acquired during running. The head tilt angle can be adjusted, for example, by feedback control. For example, the adjustment of the head tilt angle can also be performed by the method disclosed in JP2016-524774A or US2019/0164573A1.

### EXAMPLES

Hereinafter, the present invention will be described in more detail with reference to Examples. Note that the present invention is not limited to the embodiments shown in Examples. “Parts” and “%” in the following description mean “parts by mass” and “mass %”, unless otherwise noted. The following steps and evaluations are performed in the atmosphere at a room temperature (20° C. to 25° C.), unless otherwise noted. “eq” in the following description is an equivalent and is a unit that cannot be converted into an SI unit.

### Non-Magnetic Support

In Table 1, “PET” indicates a polyethylene terephthalate support, and “PA” indicates an aromatic polyamide support.

### Glass Transition Temperature Tg

The glass transition temperature Tg of each of polyurethane resins A and B shown in Table 1 was determined by the following method.

The resin (a pellet-shaped or powder-shaped sample) was placed in a sample pan made of aluminum and sealed with a pressing machine, and the heat flow was measured under the following conditions using Q100 manufactured by TA Instruments as a differential scanning calorimeter. From the measurement results, the glass transition temperature Tg of the resin was determined as the baseline shift start temperature in the heat flow chart at the time of temperature rise.

### Measurement Conditions

Scanning temperature: −80.0° C. to 200.0° ° C.
Temperature rising rate: 10.0° C./min

### Example 2

### Preparation of Alumina Dispersion (Abrasive Solution)

3.0 parts of 2,3-dihydroxynaphthalene (manufactured by Tokyo Chemical Industry Co., Ltd.), 31.3 parts of a 32% solution (solvent is a mixed solvent of methyl ethyl ketone and toluene) of a polyester polyurethane resin having a SO₃Na group as a polar group (UR-4800 manufactured by Toyobo Co., Ltd. (amount of a polar group: 80 meq/kg)), and 570.0 parts of a mixed solution of methyl ethyl ketone and cyclohexanone at 1:1 (mass ratio) as a solvent were mixed with respect to 100.0 parts of an alumina powder (HIT-80 manufactured by Sumitomo Chemical Co., Ltd.) having a pregelatinization ratio of about 65% and a BET specific surface area of 20 m²/g, and dispersed in the presence of zirconia beads by a paint shaker for 5 hours. After the dispersion, the dispersion liquid and the beads were separated by a mesh and an alumina dispersion was obtained.

### Preparation of Carbon Black Dispersion (Filler Liquid)

19.3 parts of cyclohexanone as a solvent was mixed with 3.3 parts of a filler (carbon black), and the mixture was dispersed for 360 minutes with a paint shaker in the presence of zirconia beads (bead diameter: 0.1 mm). As the filler, Asahi #50 (BET specific surface area: 23 m²/g) manufactured by Asahi Carbon Co., Ltd. was used.

After the dispersion, the carbon black dispersion obtained by separating the dispersion liquid and the beads by a mesh was used for the manufacture of the following composition for forming a magnetic layer.

### Formulation of Composition for Forming Magnetic Layer

Magnetic liquid
Ferromagnetic powder (hexagonal barium ferrite powder, activation volume: 1500 nm³): 100.0 parts
Vinyl chloride copolymer (MR-104 manufactured by Zeon Corporation): 10.0 parts
SO₃Na group-containing polyurethane resin: 4.0 parts
Weight-average molecular weight: 70,000, SO₃Na group: 0.07 meq/g
Cyclohexanone: 150.0 parts
Methyl ethyl ketone: 170.0 parts
Abrasive solution
The alumina dispersion prepared as described above is used in an amount in which the amount of alumina in the alumina dispersion is 4.5 parts
Filler liquid
The carbon black dispersion prepared as described above is used such that the amount of carbon black in the carbon black dispersion is 0.5 parts by mass
Other components
Stearic acid: 1.0 part
Butyl stearate: 3.3 parts
Polyisocyanate: (TAKENATE D-101E manufactured by Mitsui Chemicals, Inc.): 2.5 parts
Finishing additive solvent
Cyclohexanone: 300.0 parts
Methyl ethyl ketone: 140.0 parts

Formulation of composition for forming non-magnetic layer
Non-magnetic inorganic powder (α-iron oxide): see Table 1
Average particle volume: 2.0×10⁻⁶ μm³
Carbon black: see Table 1
Average particle size: 20 nm
SO₃Na group-containing vinyl chloride copolymer: 20.0 parts
Weight-average molecular weight: 70,000, SO₃Na group: 0.2 meq/g
Polyurethane resin B (glass transition temperature Tg: see Table 1): see Table 1
Weight-average molecular weight: 70,000, SO₃Na group: 0.2 meq/g
Trioctylamine: 1.0 part
Phenylphosphonic acid: 4.0 parts
Stearic acid: 1.0 part
Stearic acid amide: 0.3 parts
Butyl stearate: 3.0 parts
Cyclohexanone: 450.0 parts
Methyl ethyl ketone: 450.0 parts

Formulation of composition for forming back coating layer
Carbon black: 100.0 parts
Average particle size: 40 nm, and dibutyl phthalate (DBP) oil absorption amount: 74 cm^{3/100} g
Copper phthalocyanine: 3.0 parts
Nitrocellulose: 25.0 parts
SO₃Na group-containing polyester polyurethane resin: 60.0 parts
Weight-average molecular weight: 70,000, SO₃Na group: 0.2 meq/g
Polyester resin (VYLON 500 manufactured by Toyobo Co., Ltd.): 4.0 parts
Alumina powder (α-alumina having a BET specific surface area of 21 m²/g): 1.0 part
Polyisocyanate: (TAKENATE D-101E manufactured by Mitsui Chemicals, Inc.): 15.0 parts
Methyl ethyl ketone: 600.0 parts
Toluene: 600.0 parts

### Preparation of Composition for Forming Each Layer

The composition for forming a magnetic layer was prepared by the following method.

The magnetic liquid was prepared by mixing various components of the magnetic liquid with a homogenizer and then dispersing the beads with zirconia beads having a bead diameter of 0.05 mm by a continuous horizontal beads mill for 10 minutes.

Using the beads mill, the magnetic liquid was mixed with the abrasive solution, the filler liquid, the other components, and the finishing additive solvent, and then treated (ultrasonically dispersed) using a batch type ultrasonic device (20 kHz, 300 W) for 0.5 minutes. Thereafter, filtration was performed using a filter having a pore diameter of 0.5 μm to prepare a composition for forming a magnetic layer.

A composition for forming a non-magnetic layer was prepared by the following method.

Various components excluding stearic acid, stearic acid amide, butyl stearate were dispersed by using a batch type vertical sand mill for 12 hours to obtain a dispersion liquid. As dispersion beads, zirconia beads having a bead diameter of 0.1 mm were used. Thereafter, the remaining components were added to the obtained dispersion liquid, and the mixture was stirred by a disper. The dispersion liquid obtained as described above was filtered with a filter having a pore diameter of 0.5 μm and a composition for forming a non-magnetic layer was prepared.

A composition for forming a back coating layer was prepared by the following method.

The above components excluding polyisocyanate were introduced into a dissolver stirrer, stirred at a circumferential speed of 10 m/sec for 30 minutes, and then subjected to a dispersion treatment by a horizontal beads mill dispersing device. After that, polyisocyanate was added, and stirred and mixed by a dissolver stirrer, and a composition for forming a back coating layer was prepared.

### Manufacture of Magnetic Tape and Magnetic Tape Cartridge

The composition for forming a non-magnetic layer was applied onto a surface of a non-magnetic support (see Table 1) having a thickness of 3.9 μm and was dried so that the thickness after drying was 0.7 μm, and thus a non-magnetic layer was formed.

The composition for forming a magnetic layer was applied onto the surface of the formed non-magnetic layer so that the thickness after drying is 50 nm, and thus a coating layer was formed. While the coating layer was undried, a vertical alignment treatment was performed by applying a magnetic field having a magnetic field intensity of 0.4 T in a direction vertical to the surface of the coating layer, and the coating layer was dried.

After the coating layer was dried, the composition for forming a back coating layer was applied onto the surface on a side opposite to the surface of the polyethylene terephthalate support on which the non-magnetic layer and the magnetic layer were formed, and was dried, so that the thickness after the drying is 0.3 μm.

After that, a surface smoothing treatment (calendering treatment) was performed by using a calender roll configured of only a metal roll, at a calender speed of 100 m/min, a calender pressure (linear pressure) of 294 kN/m, and a calender temperature (surface temperature of calender roll) of 90° C.

Thereafter, after a heat treatment was performed in an environment of an atmosphere temperature described in the column of “Pre-slit heat treatment conditions” in Table 1 for a heat treatment time described in the same column, slitting was performed with a width of ½ inch (1.27 cm) and the magnetic layer surface was cleaned (referred to as “surface treatment”) with a tape cleaning device attached to a device having a feeding and winding device for a slit product such that a non-woven fabric and a razor blade press against the magnetic layer surface to obtain the magnetic tape. In Table 1, “h” indicates “hours”.

A thickness of each layer is a designed thickness calculated from the manufacturing conditions.

By recording a servo signal on a magnetic layer of the obtained magnetic tape with a commercially available servo writer, the magnetic tape including a data band, a servo band, and a guide band in the arrangement according to a linear tape-open (LTO) Ultrium format, and including a servo pattern (timing-based servo pattern) having the arrangement and shape according to the LTO Ultrium format on the servo band was obtained. The servo pattern thus formed is a servo pattern according to the description in Japanese industrial standards (JIS) X6175:2006 and Standard ECMA-319 (June 2001).

The total number of servo bands is 5, and the total number of data bands is 4.

The magnetic tape on which the servo signal is recorded was wound around a reel of a magnetic tape cartridge (LTO Ultrium 8 data cartridge). The reel of the magnetic tape cartridge has a cylindrical reel hub constituting a shaft center part. In both end parts of the reel hub, flanges (lower flange and upper flange) that protrude outward in a radial direction from a lower end part and an upper end part of the reel hub, respectively, are provided. Here, in regard to “upper” and “lower”, in a case where the magnetic tape cartridge is mounted in the magnetic tape apparatus, a side located above is referred to as “upper”, and a side located below is referred to as “lower”.

In this way, the magnetic tape cartridge in which the magnetic tape was wound on a reel and accommodated was manufactured.

For Example 2, a plurality of magnetic tape cartridges were manufactured, and each of them was used for the following evaluation.

### Edge Portion Rvm

For the magnetic tape taken out from the magnetic tape cartridge of Example 2, the edge portion Rvm of each of the edge portion on the upper flange side and the edge portion on the lower flange side was obtained by the method described above. As the noncontact optical surface roughness meter, Contour GT-I manufactured by Bruker was used. For data processing, Vision64 manufactured by Bruker was used as software. The obtained results are shown in Table 1.

### Tape Thickness of Magnetic Tape

10 measurement samples (length: 5 cm) were cut out from the magnetic tape taken out from the magnetic tape cartridge of Example 2, and these measurement samples were stacked to measure the thickness. The thickness was measured using a digital thickness gauge of Millimar 1240 compact amplifier and Millimar 1301 induction probe manufactured by MAHR Inc. A value (thickness per measurement sample) obtained by dividing the measured thickness by 1/10 was defined as the tape thickness. The tape thickness of the magnetic tape of Example 2 was 5.0 μm.

### Vertical Squareness Ratio

A measurement sample was cut out from the magnetic tape taken out from the magnetic tape cartridge of Example 2. Vertical squareness ratio of the measurement sample was obtained by the above-described method using a TM-TRVSM5050-SMSL type manufactured by Tamakawa Co., Ltd. as a vibrating sample magnetometer. The vertical squareness ratio of the magnetic tape of Example 2 was 0.65.

### Running Stability

In an environment of a temperature of 40° C. and a relative humidity of 10%, running stability was evaluated by the following method.

Using the magnetic tape cartridge of Example 2, recording and reproduction of data were performed using the magnetic tape apparatus having the configuration shown in FIG. 7. The arrangement order of the modules included in the recording and reproducing head mounted on the recording and reproducing head unit is “recording module—reproducing module—recording module” (total number of modules: 3). The number of magnetic head elements in each module is 32 (Ch0 to Ch31), and the element array is configured by sandwiching these magnetic head elements between the pair of servo signal reading elements.

The recording and reproduction of data and evaluating of the running stability during the reproducing by the following method were executed with the head tilt angle set to 15°. The head tilt angle is an angle θ formed by the axis of the element array of the reproducing module with respect to the width direction of the magnetic tape at the start of running. The angle θ was set by the control device of the magnetic tape apparatus at the start of running of the magnetic tape, and the head tilt angle was fixed during running of the magnetic tape.

The magnetic tape cartridge was set in the magnetic tape apparatus and the magnetic tape was loaded. Next, pseudo random data having a specific data pattern was recorded on the magnetic tape by the recording and reproducing head unit while performing servo tracking. In this case, the tension applied in the tape longitudinal direction was set to a constant value. Simultaneously with the recording of the data, the value of the servo band interval of the tape entire length was measured at every 1 m of the longitudinal position and recorded in the cartridge memory.

Then, the data recorded on the magnetic tape was reproduced by the recording and reproducing head unit while performing servo tracking. In this case, the tension applied in the tape longitudinal direction was set to a constant value.

The running stability was evaluated using, as an index, standard deviation (hereinafter, referred to as “σPES”) of a reading position error signal (PES) in the width direction based on the servo signal obtained by the servo signal reading element during the reproduction.

The PES was obtained by the following method.

In order to obtain the PES, the dimensions of the servo pattern are required. The standards of the dimensions of the servo pattern depend on the generation of LTO. First, an average distance AC between four stripes corresponding to an A burst and a C burst and an azimuth angle α of the servo pattern were measured by using a magnetic force microscope or the like.

An average time between five stripes corresponding to the A burst and the B burst over a length of one LPOS word is defined as a. An average time between four stripes corresponding to the A burst and the C burst over the length of one LPOS word is defined as b. In this case, a value defined by AC×(½−a/b)/(2×tan(α)) represents a reading position error signal (PES) in the width direction based on the servo signal obtained by the servo signal reading element over a length of one LPOS word. For the magnetic tape, the standard deviation (σPES) of the PES obtained by the above method was calculated in the final reciprocating by repeatedly reciprocating the tape 3500 times in an environment of a temperature of 40° C. and a relative humidity of 10%, for a region in the tape longitudinal direction over a length of 30 m to 200 m, where a terminal on the side wound around the reel of the magnetic tape cartridge is called an inner terminal, a terminal on the opposite side is called an outer terminal, and the outer terminal is set to 0 m. In a case where the σPES obtained in this way is 70 nm or less, it can be determined that the running stability is excellent.

### Examples 5 and 6 and Comparative Example 6

A magnetic tape and a magnetic tape cartridge were manufactured and various evaluations were performed by the method described in Example 2, except that the items shown in Table 1 were changed as shown in Table 1. The obtained results are shown in Table 1.

### Comparative Example 7

A magnetic tape and a magnetic tape cartridge were manufactured by the method described in Example 2, except that the items shown in Table 1 were changed as shown in Table 1. In Comparative Example 7, as the polyurethane resin of the non-magnetic layer, the polyurethane resin A having the glass transition temperature Tg shown in Table 1 was used instead of the polyurethane resin B. As a result of performing various evaluations as described in Example 2 using the magnetic tape cartridge manufactured in this way, the results shown in Table 1 were obtained.

### Example 1 and Comparative Example 5

A magnetic tape and a magnetic tape cartridge are manufactured by the method described in Comparative Example 7, except that the items shown in Table 1 are changed as shown in Table 1. In a case where various evaluations are performed using the magnetic tape cartridge manufactured in this way as described in Example 2, the results shown in Table 1 are obtained.

### Examples 3 and 4 and Comparative Examples 1 and 3

A magnetic tape and a magnetic tape cartridge are manufactured by the method described in Example 2, except that the items shown in Table 1 are changed as shown in Table 1. In a case where various evaluations are performed as described in Example 2 using the magnetic tape cartridge manufactured in this way, the results shown in Table 1 are obtained.

### Comparative Example 2

A magnetic tape and a magnetic tape cartridge are manufactured by the method described in Example 2, except that the items shown in Table 1 are changed as shown in Table 1 and the rewinding of the magnetic tape is performed after the slitting and before the surface treatment.

Comparative Example 2 is the same as Comparative Example 1 except that the rewinding is performed before the surface treatment. The magnetic tape is accommodated in the magnetic tape cartridge by rewinding before the surface treatment, so that the edge portion on the upper flange side in Comparative Example 1 is located on the lower flange side and the edge portion on the lower flange side in Comparative Example 1 is located on the upper flange side.

In a case where various evaluations are performed using the magnetic tape cartridge manufactured in this way as described in Example 2, the results shown in Table 1 are obtained.

In Table 1, in a case where the rewinding is not performed before the surface treatment, “Absent” is described in the column of “Rewinding before surface treatment”. In a case where the rewinding is performed before the surface treatment, “Present” is described in the column of “Rewinding before surface treatment”.

### Comparative Example 4

A magnetic tape and a magnetic tape cartridge are manufactured by the method described in Example 2, except that the items shown in Table 1 are changed as shown in Table 1 and the rewinding of the magnetic tape is performed after the slitting and before the surface treatment.

Comparative Example 4 is the same as Comparative Example 3 except that the rewinding is performed before the surface treatment. The magnetic tape is accommodated in the magnetic tape cartridge by rewinding before the surface treatment, so that the edge portion on the upper flange side in Comparative Example 3 is located on the lower flange side and the edge portion on the lower flange side in Comparative Example 3 is located on the upper flange side.

In a case where various evaluations are performed using the magnetic tape cartridge manufactured in this way as described in Example 2, the results shown in Table 1 are obtained.

The details of Examples 1 to 6 and Comparative Examples 1 to 7 are shown in Table 1 (Tables 1-1 to 1-7).

TABLE 1-1

| | | | Example 1 | | Example 2 | |
|---|---|---|---|---|---|---|
| Non-magnetic | α-iron oxide | Amount | 100.0 | parts by mass | 100.0 | parts by mass |
| layer | Carbon black | Amount | 25.0 | parts by mass | 25.0 | parts by mass |
| | Polyurethane | Type | Polyurethane resin A | | Polyurethane resin B | |
| | resin | Tg | 50° | C. | 110° | C. |
| | | Amount | 10.0 | parts by mass | 10.0 | parts by mass |

| Non-magnetic support | PET | | PET | |
|---|---|---|---|---|
| Pre-slit heat treatment conditions | 65° C. 36 h | | 65° C. 36 h | |
| Rewinding before surface treatment | Absent | | Absent | |
| Edge portion Rvm (upper flange side) | −0.35 | μm | −0.43 | μm |
| Edge portion Rvm (lower flange side) | −0.28 | μm | −0.36 | μm |
| σPES (temperature of 40° C., | 27 | nm | 30 | nm |
| relative humidity of 10%) | | | | |

TABLE 1-2

| | | | Example 3 | | Example 4 | |
|---|---|---|---|---|---|---|
| Non-magnetic | α-iron oxide | Amount | 100.0 | parts by mass | 75.0 | parts by mass |
| layer | Carbon black | Amount | 25.0 | parts by mass | 50.0 | parts by mass |
| | Polyurethane | Type | Polyurethane resin B | | Polyurethane resin B | |
| | resin | Tg | 110° | C. | 110° | C. |
| | | Amount | 10.0 | parts by mass | 10.0 | parts by mass |

| Non-magnetic support | PET | | PET | |
|---|---|---|---|---|
| Pre-slit heat treatment conditions | 50° C. 36 h | | 50° C. 36 h | |
| Rewinding before surface treatment | Absent | | Absent | |
| Edge portion Rvm (upper flange side) | −0.40 | μm | −0.35 | μm |
| Edge portion Rvm (lower flange side) | −0.35 | μm | −0.30 | μm |
| σPES (temperature of 40° C., | 28 | nm | 27 | nm |
| relative humidity of 10%) | | | | |

TABLE 1-3

| | | | Example 5 | | Example 6 | |
|---|---|---|---|---|---|---|
| Non-magnetic | α-iron oxide | Amount | — | | 100.0 | parts by mass |
| layer | Carbon black | Amount | 125.0 | parts by mass | 25.0 | parts by mass |
| | Polyurethane | Type | Polyurethane resin B | | Polyurethane resin B | |
| | resin | Tg | 110° | C. | 110° | C. |
| | | Amount | 10.0 | parts by mass | 10.0 | parts by mass |

| Non-magnetic support | PET | | PA | |
|---|---|---|---|---|
| Pre-slit heat treatment conditions | 65° C. 36 h | | 65° C. 36 h | |
| Rewinding before surface treatment | Absent | | Absent | |
| Edge portion Rvm (upper flange side) | −0.30 | μm | −0.42 | μm |
| Edge portion Rvm (lower flange side) | −0.25 | μm | −0.37 | μm |
| σPES (temperature of 40° C., | 24 | nm | 31 | nm |
| relative humidity of 10%) | | | | |

TABLE 1-4

| | | | Comparative Example 1 | | Comparative Example 2 | |
|---|---|---|---|---|---|---|
| Non-magnetic | α-iron oxide | Amount | 115.0 | parts by mass | 115.0 | parts by mass |
| layer | Carbon black | Amount | 10.0 | parts by mass | 10.0 | parts by mas |
| | Polyurethane | Type | Polyurethane resin B | | Polyurethane resin B | |
| | resin | Tg | 110° | C. | 110° | C. |
| | | Amount | 10.0 | parts by mas | 10.0 | parts by mas |

| Non-magnetic support | PET | | PET | |
|---|---|---|---|---|
| Pre-slit heat treatment conditions | 75° C. 54 h | | 75° C. 54 h | |
| Rewinding before surface treatment | Absent | | Present | |
| Edge portion Rvm (upper flange side) | −0.57 | μm | −0.45 | μm |
| Edge portion Rvm (lower flange side) | −0.45 | μm | −0.57 | μm |
| σPES (temperature of 40° C., | 80 | nm | 79 | nm |
| relative humidity of 10%) | | | | |

TABLE 1-5

| | | | Comparative Example 3 | | Comparative Example 4 | |
|---|---|---|---|---|---|---|
| Non-magnetic | α-iron oxide | Amount | 115.0 | parts by mass | 115.0 | parts by mass |
| layer | Carbon black | Amount | 10.0 | parts by mass | 10.0 | parts by mas |
| | Polyurethane | Type | Polyurethane resin B | | Polyurethane resin B | |
| | resin | Tg | 110° | C. | 110° | C. |
| | | Amount | 10.0 | parts by mass | 10.0 | parts by mas |

| Non-magnetic support | PET | | PET | |
|---|---|---|---|---|
| Pre-slit heat treatment conditions | 65° C. 36 h | | 65° C. 36 h | |
| Rewinding before surface treatment | Absent | | Present | |
| Edge portion Rvm (upper flange side) | −0.56 | μm | −0.48 | μm |
| Edge portion Rvm (lower flange side) | −0.48 | μm | −0.56 | μm |
| σPES (temperature of 40° C., | 78 | nm | 79 | nm |
| relative humidity of 10%) | | | | |

TABLE 1-6

| | | | Comparative Example 5 | | Comparative Example 6 | |
|---|---|---|---|---|---|---|
| Non-magnetic | α-iron oxide | Amount | 115.0 | parts by mass | 100.0 | parts by mass |
| layer | Carbon black | Amount | 10.0 | parts by mass | 25.0 | parts by mas |
| | Polyurethane | Type | Polyurethane resin A | | Polyurethane resin B | |
| | resin | Tg | 50° | C. | 110° | C. |
| | | Amount | 10.0 | parts by mass | 20.0 | parts by mas |

| Non-magnetic support | PET | | PET | |
|---|---|---|---|---|
| Pre-slit heat treatment conditions | 75° C. 54 h | | 75° C. 54 h | |
| Rewinding before surface treatment | Absent | | Absent | |
| Edge portion Rvm (upper flange side) | −0.57 | μm | −0.56 | μm |
| Edge portion Rvm (lower flange side) | −0.43 | μm | −0.43 | μm |
| σPES (temperature of 40° C., | 76 | nm | 76 | nm |
| relative humidity of 10%) | | | | |

TABLE 1-7

| | | | Comparative Example 7 | |
|---|---|---|---|---|
| Non-magnetic | α-iron oxide | Amount | — | |
| layer | Carbon black | Amount | 125.0 | parts by mass |
| | Polyurethane | Type | Polyurethane resin A | |
| | resin | Tg | 50° | C. |
| | | Amount | 10.0 | parts by mass |

| Non-magnetic support | PET | |
|---|---|---|
| Pre-slit heat treatment conditions | 50° C. 36 h | |
| Rewinding before surface treatment | Absent | |
| Edge portion Rvm (upper flange side) | −0.19 | μm |
| Edge portion Rvm (lower flange side) | −0.18 | μm |
| σPES (temperature of 40° C., | 72 | nm |
| relative humidity of 10%) | | |

As shown in Table 1. the magnetic tapes of Examples 1 to 6 are magnetic tapes having excellent running stability.

One aspect of the present invention is useful in various data storage technical fields.

What is claimed is:

1. A magnetic tape comprising:
a non-magnetic support; and
a magnetic layer containing a ferromagnetic powder,
wherein both an average valley depth Rvm measured at one edge portion of a surface of the magnetic layer and an average valley depth Rvm measured at the other edge portion are −0.55 μm or more and −0.20 μm or less, and
the edge portion is a portion of 0 μm to 1 μm in a tape width direction in a case where a position of an edge is 0 μm.

2. The magnetic tape according to claim 1,
wherein a tape thickness of the magnetic tape is 5.0 μm or less.

3. The magnetic tape according to claim 1,
wherein a vertical squareness ratio of the magnetic tape is 0.65 or more.

4. The magnetic tape according to claim 1,
wherein the non-magnetic support is an aromatic polyester support.

5. The magnetic tape according to claim 1,
wherein the non-magnetic support is an aromatic polyamide support.

6. The magnetic tape according to claim 1, further comprising:
a non-magnetic layer containing a non-magnetic powder between the non-magnetic support and the magnetic layer.

7. The magnetic tape according to claim 1, further comprising:
a back coating layer containing a non-magnetic powder on a surface side of the non-magnetic support opposite to a surface side having the magnetic layer.

8. The magnetic tape according to claim 1,
wherein a tape thickness of the magnetic tape is 5.0 μm or less,
a vertical squareness ratio of the magnetic tape is 0.65 or more,
the non-magnetic support is an aromatic polyester support or an aromatic polyamide support,
the magnetic tape further includes a non-magnetic layer containing a non-magnetic powder between the non-magnetic support and the magnetic layer, and
the magnetic tape further includes a back coating layer containing a non-magnetic powder on a surface side of the non-magnetic support opposite to a surface side having the magnetic layer.

9. A magnetic tape cartridge comprising:
the magnetic tape according to claim 1.

10. A magnetic tape apparatus comprising:
the magnetic tape according to claim 1.

11. The magnetic tape apparatus according to claim 10, further comprising:
a magnetic head,
wherein the magnetic head has a module including an element array with a plurality of magnetic head elements between a pair of servo signal reading elements, and
the magnetic tape apparatus changes an angle θ formed by an axis of the element array with respect to a width direction of the magnetic tape during running of the magnetic tape in the magnetic tape apparatus.
